(19) United States
(12) Patent Application Publication
(10) Pub. No.: US 2017/0034525 A1
(43) Pub. Date: Feb. 2, 2017

(54) IMAGE PROCESSING DEVICE AND IMAGE PROCESSING METHOD

(71) Applicant: SONY CORPORATION, Tokyo (JP)

(72) Inventor: KAZUSHI SATO, KANAGAWA (JP)

(21) Appl. No.: 14/787,395

(22) PCT Filed: Jan. 29, 2015
(86) PCT No.: PCT/JP2015/052512

§ 371 Date: Oct. 27, 2015

(30) Foreign Application Priority Data
Mar. 28, 2014 (JP) 2014-069437

(51) Int. Cl. H04N 19/503; H04N 19/109; H04N 19/154; H04N 19/186; H04N 19/36; H04N 19/463; H04N 19/184; H04N 19/70; H04N 19/172

(52) U.S. Cl. CPC H04N 19/503; H04N 19/70; H04N 19/109; H04N 19/154; H04N 19/172; H04N 19/36; H04N 19/463; H04N 19/184; H04N 19/186

(57) ABSTRACT

[Object] To avoid the redundant coding of the bit-depth-related information.

[Solution] Provided is an image processing device including: an acquisition section configured to acquire first bit depth information for decoding a luma component of an encoded image and second bit depth information for decoding a chroma component of the encoded image; and a decoding section configured to decode the luma component according to the first bit depth information and decode the chroma component according to the second bit depth information. The decoding section decodes the chroma component according to a second bit depth that is calculated based on a first bit depth indicated by the first bit depth information and a bit depth difference indicated by the second bit depth information.

### TECHNICAL FIELD

The present disclosure relates to an image processing device and an image processing method.

### BACKGROUND ART

The standardization of an image coding scheme called HEVC (High Efficiency Video Coding) by JCTVC (Joint Collaboration Team-Video Coding), which is a joint standardization organization of ITU-T and ISO/IEC, is currently under way for the purpose of improving coding efficiency more than H. 264/AVC (see, for example, Non-Patent Literature 1).

HEVC provides not only coding of a single layer but also scalable video coding, as in known image coding schemes such as MPEG2 and AVC (Advanced Video Coding). An HEVC scalable video coding technology is also called SHVC (Scalable HEVC) (for example, see Non-Patent Literature 2). Scalable video coding commonly refers to a technique of hierarchically encoding a layer in which a coarse image signal is transmitted and a layer in which a fine image signal is transmitted.

A first version of a standard specification of HEVC was published at the beginning of 2013, but the specification has been continuously extended from various viewpoints such as improvement of a coding tool in addition to SHVC (for example, see Non-Patent Literature 3). For example, a bit depth of a pixel usable in HEVC is commonly 8 bits or 10 bits. However, a larger bit depth becomes usable by supporting the extension described in Non-Patent Literature 3.

### CITATION LIST

### Non-Patent Literature

Non-Patent Literature 1: Benjamin Bross, el. al, “High Efficiency Video Coding (HEVC) text specification draft 10 (for FDIS & Consent)” (JCTVC-L1003_v4, Jan. 14 to 23, 2013)
Non-Patent Literature 2: Jianle Chen, el. al, “High efficiency video coding (HEVC) scalable extensions Draft 5” (JCTVC-P1008_v4, Jan. 9 to 17, 2014)
Non-Patent Literature 3: David Flynn, el. al, “High Efficiency Video Coding (HEVC) Range Extensions text specification: Draft 5” (JCTVC-O1005_v2, Oct. 23 to Nov. 1, 2013)

### SUMMARY OF INVENTION

### Technical Problem

However, in the known specification, various coding tools are provided, but an information amount of bit-depth-related information is consequently increased. In normal use of a video codec, since it is considered uncommon to deal with several different bit depths at the same time, it is desirable to avoid redundant coding of the bit-depth-related information.

### Solution to Problem

According to the present disclosure, there is provided an image processing device including: an acquisition section configured to acquire first bit depth information for decoding a luma component of an encoded image and second bit depth information for decoding a chroma component of the encoded image; and a decoding section configured to decode the luma component according to the first bit depth information and decode the chroma component according to the second bit depth information. The decoding section decodes the chroma component according to a second bit depth that is calculated based on a first bit depth indicated by the first bit depth information and a bit depth difference indicated by the second bit depth information.

According to the present disclosure, there is provided an image processing device including: an acquisition section configured to acquire non-PCM bit depth information for decoding a non-PCM sample of an encoded image and PCM bit depth information for decoding a PCM sample of the encoded image; and a decoding section configured to decode the non-PCM sample according to the non-PCM bit depth information and decode the PCM sample according to the PCM bit depth information. The decoding section decodes the PCM sample according to a PCM bit depth that is calculated based on a non-PCM bit depth indicated by the non-PCM bit depth information and a first bit depth difference indicated by the PCM bit depth information.

According to the present disclosure, there is provided an image processing device including: an encoding section configured to encode a luma component of an image according to a first bit depth and encode a chroma component of the image according to a second bit depth; and a generation section configured to generate first bit depth information indicating the first bit depth and second bit depth information indicating a bit depth difference between the first bit depth and the second bit depth. The encoding section further encodes the first bit depth information and the second bit depth information.

According to the present disclosure, there is provided an image processing device including: an encoding section configured to encode a non-PCM sample of an image and a PCM sample of the image according to bit depths that are defined separately; and a generation section configured to generate non-PCM bit depth information indicating a non-PCM bit depth and PCM bit depth information indicating a first bit depth difference between the non-PCM bit depth and a PCM bit depth. The encoding section further encodes the non-PCM bit depth information and the PCM bit depth information.

### Advantageous Effects of Invention

According to the technology of the present disclosure, it is possible to avoid the redundant coding of the bit-depth-related information and improve the coding efficiency.

The effect is not necessarily limited, and in addition to the effect or instead of the effect, any effect described in this specification or any other effect that can be understood from this specification may be obtained.

### BRIEF DESCRIPTION OF DRAWINGS

FIG. 1 is a block diagram showing an example of a configuration of an image encoding device according to an embodiment.

FIG. 2 is a block diagram showing an example of a detailed configuration of a bit depth control section illustrated in FIG. 1.

FIG. 3 is a block diagram showing an example of a detailed configuration of a weighted prediction section illustrated in FIG. 1.

FIG. 4 is a flowchart showing an example of the flow of a schematic process at the time of encoding according to an embodiment.

FIG. 5 is a flowchart showing an example of the flow of a bit depth information generation process according to an embodiment.

FIG. 6 is a flowchart showing an example of the flow of a WP information generation process according to an embodiment.

FIG. 7 is a block diagram showing an example of a configuration of an image decoding device according to an embodiment.

FIG. 8 is a block diagram showing an example of a detailed configuration of a bit depth control section illustrated in FIG. 7.

FIG. 9 is a block diagram showing an example of a detailed configuration of a weighted prediction section illustrated in FIG. 7.

FIG. 10 is a flowchart showing an example of the flow of a schematic process at the time of decoding according to an embodiment.

FIG. 11 is a flowchart showing an example of the flow of a bit depth calculation process according to an embodiment.

FIG. 12 is a flowchart showing an example of the flow of a WP parameter calculation process according to an embodiment.

FIG. 13 is a block diagram showing an example of a schematic configuration of a television.

FIG. 14 is a block diagram showing an example of a schematic configuration of a mobile phone.

FIG. 15 is a block diagram showing an example of a schematic configuration of a recording/reproduction device.

FIG. 16 is a block diagram showing an example of a schematic configuration of an image capturing device.

FIG. 17 is a block diagram showing a schematic configuration of an image encoding device that supports scalable video coding.

FIG. 18 is a block diagram showing a schematic configuration of an image decoding device that supports scalable video coding.

FIG. 19 is an explanatory view illustrating a first example of use of the scalable video coding.

FIG. 20 is an explanatory view illustrating a second example of use of the scalable video coding.

FIG. 21 is an explanatory view illustrating a third example of use of the scalable video coding.

FIG. 22 is an explanatory view illustrating a multi-view codec.

FIG. 23 is a block diagram showing a schematic configuration of the image encoding device for multi-view codec.

FIG. 24 is a block diagram showing a schematic configuration of the image decoding device for multi-view codec.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

The description will proceed in the following order.

1. Overview of bit-depth-related information

2. Example of configuration of image encoding device according to embodiment

3. Process flow for encoding according to embodiment

4. Example of configuration of image decoding device according to embodiment

5. Process flow for decoding according to embodiment

6. Example application

7. Scalable video coding

8. Conclusion

### 1. OVERVIEW OF BIT-DEPTH-RELATED INFORMATION

[1-1. Bit Depth Information]

According to Non-Patent Literature 1, a sequence parameter set (SPS) includes the following four types of bit depth information:
luma bit depth information;
chroma bit depth information;
PCM luma bit depth information; and
PCM chroma bit depth information.

The luma bit depth information is information indicating a bit depth used when a luma component of an image is encoded or decoded. The chroma bit depth information is information indicating a bit depth used when a chroma component of an image is encoded or decoded. Since a normal sample is encoded and decoded according to a non-pulse code modulation (PCM) scheme (typically, a differential pulse code modulation (DPCM) scheme), in this specification, the luma bit depth information and the chroma bit depth information are referred to collectively as “non-PCM bit depth information.” PCM luma bit depth information is information indicating a bit depth used when a luma component of a PCM sample of an image is encoded or decoded. PCM chroma bit depth information is information indicating a bit depth used when a chroma component of a PCM sample of an image is encoded or decoded. In this specification, the PCM luma bit depth information and the PCM chroma bit depth information are referred to collectively as “PCM bit depth information.” The following Table 1 illustrates a portion related to the bit depth information in the syntax of the SPS in Non-Patent Literature 1.

TABLE 1

| seq_parameter_set_rbsp( ){ | Descriptor |
|---|---|
| : | |
| bit_depth_luma_minus8 | ue(v) |
| bit_depth_chroma_minus8 | ue(v) |
| : | |
| if(pcm_enabled_flag){ | |
| pcm_sample_bit_depth_luma_minus1 | u(4) |
| pcm_sample_bit_depth_chroma_minus1 | u(4) |
| : | |
| } | |
| : | |
| } | |

In Table 1, a parameter bit_depth_luma_minus8 corresponds to the luma bit depth information, and indicates a value obtained by subtracting 8 from a bit depth of a luma component of a non-PCM sample. A parameter bit_depth_chroma_minus8 corresponds to the chroma bit depth information, and indicates a value obtained by subtracting 8 from a bit depth of a chroma component of a non-PCM sample. For example, when both the luma component and the chroma component are encoded by bits, both of the parameters bit_depth_luma_minus8 and bit_depth_chroma_minus8 are “2.”

In Table 1, a parameter pcm_sample_bit_depth_luma_minus1 corresponds to the PCM luma bit depth information, and indicates a value obtained by subtracting 1 from a bit depth of a luma component of a PCM sample. A parameter pcm_sample_bit_depth_chroma_minus1 corresponds to the PCM chroma bit depth information, and indicates a value obtained by subtracting 1 from a bit depth of a chroma component of a PCM sample. The parameters pcm_sample_bit_depth_luma_minus1 and pcm_sample_bit_depth_chroma_minus1 are encoded when a flag pcm_enabled_flag is set to true, that is, when PCM coding is enabled.

According to Non-Patent Literature 2, in SHVC, the SPS of the base layer includes the non-PCM bit depth information and the PCM bit depth information. The SPS of the enhancement layer includes an index of a representation format when the representation format is updated, and the representation format designated by the index includes the non-PCM bit depth information that is applied to the enhancement layer. The following Table 2 illustrates a portion related to the bit depth information in the syntax of the representation format in Non-Patent Literature 2.

TABLE 2

| rep_format( ){ | Descriptor |
|---|---|
| : | |
| chroma_and_bit_depth_vps_present_flag | u(1) |
| if(chroma_and_bit_depth_vps_present_flag){ | |
| : | |
| bit_depth_vps_luma_minus8 | u(4) |
| bit_depth_vps_chroma_minus8 | u(4) |
| : | |
| } | |
| } | |

In Table 1, a parameter bit_depth_vps_luma_minus8 may correspond to the luma bit depth information, and a parameter bit_depth_vps_chroma_minus8 may correspond to the chroma bit depth information.

As described above, in the known specification, a number of types of bit depth information are encoded. As the bit depth information is defined as a coding parameter, various coding tools can be utilized in order to optimize operations of an encoder and a decoder from an arbitrary viewpoint such as image quality, a compression ratio, or a processing cost. However, in the normal use, it is considered uncommon to deal with several different bit depths at the same time. For example, the luma component and the chroma component may have the same bit depth. A non-PCM bit depth may be identical to a PCM bit depth. Using a correlation between different types of bit depths, it is possible to exclude redundancy of the bit-depth-related information and further improve the coding efficiency.

[1-2. Weighted Prediction Information]

According to Non-Patent Literature 3, a slice header includes a syntax for weighted prediction information designating a parameter (typically, a weight and an offset) used in the weighted prediction. The weighted prediction is a coding tool introduced to improve prediction information of inter prediction for a video to which an effect such as fade-in or fade-out is applied. The following Table 3 partially illustrates a syntax for the weighted prediction information in Non-Patent Literature 3.

TABLE 3

| pred_weight_table( ){ | Descriptor |
|---|---|
| luma_log2_weight_denom | ue(v) |
| if(chroma_format_idcChromaArrayType != 0) | |
| delta_chroma_log2_weight_denom | se(v) |
| for(i=0; i <= num_ref_idx_l0_active_minus1; i++) | |
| luma_weight_l0_flag[i] | u(1) |
| if(chroma_format_idcChromaArrayType != 0) | |
| for(i=0; i <= num_ref_idx_l0_active_minus1; i++) | |
| chroma_weight_l0_flag[i] | u(1) |
| for(i=0; i <= num_ref_idx_l0_active_minus1; i++) { | |
| if(luma_weight_l0_flag[i] ) { | |
| delta_luma_weight_l0[i] | se(v) |
| luma_offset_l0[i] | se(v) |
| } | |
| if(chroma_weight_l0_flag[i] ) | |
| for(j=0; j < 2; j++ ) { | |
| delta_chroma_weight_l0[i][j] | se(v) |
| delta_chroma_offset_l0[i][j] | se(v) |
| } | |
| } | ue(v) |
| : | |
| } | se(v) |

The weighted prediction information actually includes a portion defining a parameter corresponding to an L0 reference frame and a portion defining a parameter corresponding to an L1 reference frame, but for the sake of simplicity of description, the portion defining the parameter corresponding to the L1 reference frame is omitted in Table 3. As can be understood from Table 3, a weight applied to the luma component is given in the form of a fraction by designating a denominator through a parameter luma_log 2_weight_denom and designating a numerator through a parameter delta_luma_weight_10[i]. A weight applied to the chroma component is given in the form of a fraction by designating a denominator through a parameter delta_chroma_log 2_weight_denom (indicating a difference with the denominator of the weight of the luma component) and designating a numerator through a parameter delta_chroma_weight_10[i][j].

The weighted prediction information does not directly indicate a bit depth. However, it is desirable that the weight be more finely adjusted as the bit depth increases. For this reason, in an embodiment which will be described later, generation of denominator information is controlled in association with bit depth information, particularly in view of a correlation between a weight denominator and a bit depth. In this specification, the bit depth information and information such as the weighted prediction information controlled in association with the bit depth information are referred to collectively as “bit-depth-related information.”

### 2. EXAMPLE OF CONFIGURATION OF IMAGE ENCODING DEVICE ACCORDING TO EMBODIMENT

[2-1. Overall Configuration Example]

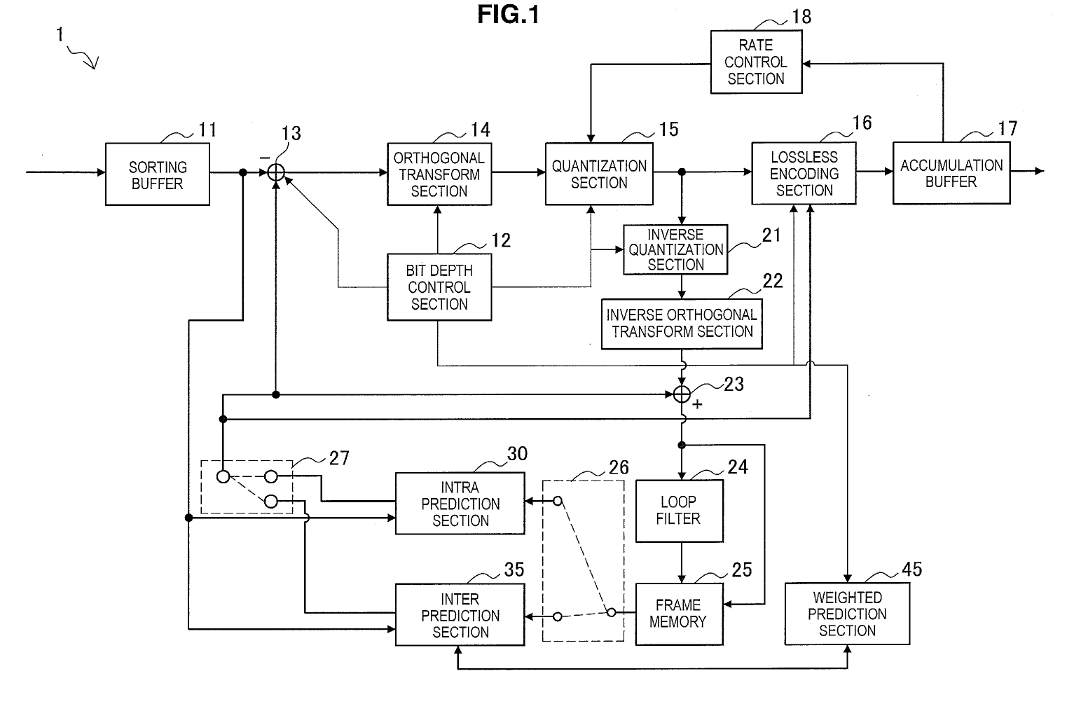

FIG. 1 is a block diagram showing an example of a configuration of an image encoding device 1 according to an embodiment. Referring to FIG. 1, the image encoding device 1 includes a sorting buffer 11, a bit depth control section 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a loop filter 24, a frame memory 25, selectors 26 and 27, an intra prediction section 30, an inter prediction section 35, and a weighted prediction section 45.

The sorting buffer 11 sorts images included in a series of image data of a video to be encoded. The sorting buffer 11 sorts the images according to a group of pictures (GOP) structure related to an encoding process, and then outputs the sorted image data to the subtraction section 13, the intra prediction section 30, and the inter prediction section 35.

The bit depth control section 12 holds settings related to various types of bit depths related to the encoding process in the image encoding device 1, and controls a bit depth of image data to be encoded according to a corresponding setting. The bit depth control section 12 generates the bit depth information necessary for decoding the image data. The bit depth information generated by the bit depth control section 12 includes at least the luma bit depth information and the chroma bit depth information. When PCM coding is enabled, the bit depth information generated by the bit depth control section 12 may further include the PCM luma bit depth information and the PCM chroma bit depth information. The bit depth information has a code amount reduced to be smaller than information based on the known specification as will be further described later. The bit depth control section 12 outputs the generated bit depth information to the lossless encoding section 16.

The subtraction section 13 is supplied with the image data (original image data) input from the sorting buffer 11 and prediction image data input from the intra prediction section 30 or the inter prediction section 35 which will be described later. The subtraction section 13 calculates prediction error data serving as a difference between the image data input from the sorting buffer 11 and prediction image data for the non-PCM sample, and outputs the calculated prediction error data to the orthogonal transform section 14. The bit depth control section 12 skips the calculation of the prediction error data by the subtraction section 13 for the PCM sample. In this case, the subtraction section 13 outputs the PCM sample of the original image data without change.

The orthogonal transform section 14 performs an orthogonal transform on the prediction error data of the non-PCM sample input from the subtraction section 13. The orthogonal transform executed by the orthogonal transform section 14 may be, for example, a discrete cosine transform (DCT), a Karhunen-Loève transform, or the like. The orthogonal transform section 14 outputs transform coefficient data acquired by the orthogonal transform process to the quantization section 15. The bit depth control section 12 skips execution of the orthogonal transform process by the orthogonal transform section 14 for the PCM sample. In this case, the orthogonal transform section 14 outputs the PCM sample of the original image data to the quantization section 15 without change.

The quantization section 15 is supplied with the transform coefficient data of the non-PCM sample or the image data of the PCM sample input from the orthogonal transform section 14 or a rate control signal input from the rate control section 18 which will be described later. When the transform coefficient data of the non-PCM sample is supplied, the quantization section 15 quantizes the transform coefficient data using a quantization step decided according to the rate control signal. Further, when the image data of the PCM sample is supplied, the quantization section 15 quantizes the image data by performing a bit shift of a shift amount decided according to the rate control signal. Then, the quantization section 15 outputs the quantized data to the lossless encoding section 16 and the inverse quantization section 21.

The lossless encoding section 16 generates an encoded stream by performing a lossless encoding process on the quantized data input from the quantization section 15. The luma component of the image and the chroma component may be encoded at the same bit depth or may be encoded at different bit depths. The luma component and the chroma component of the PCM sample may be encoded at the same bit depth or at a different bit depth from the luma component and the chroma component of the non-PCM sample. The lossless encoding section 16 encodes various parameters that are referred to when the encoded stream is decoded, and inserts the encoded parameters into a header region of the encoded stream. For example, the lossless encoding section 16 encodes the bit depth information input from the bit depth control section 12, and inserts the encoded bit depth information into the SPS. The parameters encoded by the lossless encoding section 16 include intra-prediction-related information and inter-prediction-related information which will be described later. The information related to the inter prediction may include the weighted prediction information. Then, the lossless encoding section 16 outputs the generated encoded stream to the accumulation buffer 17.

The accumulation buffer 17 temporarily accumulates an encoded stream input from the lossless encoding section 16 using a storage medium such as a semiconductor memory. Then, the accumulation buffer 17 outputs the accumulated encoded stream to a transmission section (not shown) (for example, a communication interface or an interface to peripheral devices) at a rate in accordance with the band of a transmission path.

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21, the inverse orthogonal transform section 22, and the addition section 23 configure a local decoder. The inverse quantization section 21 inversely quantizes the quantized data using the same quantization step or the same bit shift amount as one used by the quantization section 15, and restores the transform coefficient data of the non-PCM sample or the image data of the PCM sample. Then, the inverse quantization section 21 outputs the restored data to the inverse orthogonal transform section 22.

The inverse orthogonal transform section 22 restores the prediction error data by performing the inverse orthogonal transform process on the transform coefficient data of the non-PCM sample input from the inverse quantization section 21. Then, the inverse orthogonal transform section 22 outputs the restored prediction error data to the addition section 23. For the PCM sample, the inverse orthogonal transform process is not executed, and the decoded image data of the PCM sample is output without change.

The addition section 23 generates the decoded image data (reconstructed image) by adding the prediction error data of the non-PCM sample input from the inverse orthogonal transform section 22 to the prediction image data input from the intra prediction section 30 or the inter prediction section 35. Then, the addition section 23 outputs the generated decoded image data to the loop filter 24 and the frame memory 25. For the PCM sample, the addition of the prediction error data is not executed, and the decoded image data of the PCM sample is output without change.

The loop filter 24 includes a filter group for the purpose of improving image quality. A deblock filter (DF) is a filter that reduces block distortion occurring when an image is encoded. A sample adaptive offset (SAO) filter is a filter that adds an adaptively determined offset value to each pixel value. The loop filter 24 filters the decoded image data input from the addition section 23 and outputs the filtered decoded image data to the frame memory 25.

The frame memory 25 stores the decoded image data input from the addition section 23 and the filtered decoded image data input from the loop filter 24 using a storage medium.

The selector 26 reads the decoded image data before the filtering used for the intra prediction from the frame memory 25 and supplies the read decoded image data as reference image data to the intra prediction section 30. Further, the selector 26 reads the filtered decoded image data used for the inter prediction from the frame memory 25 and supplies the read decoded image data as reference image data to the inter prediction section 35.

In the intra prediction mode, the selector 27 outputs prediction image data as a result of intra prediction output from the intra prediction section 30 to the subtraction section 13 and also outputs information about the intra prediction to the lossless encoding section 16. Further, in the inter prediction mode, the selector 27 outputs prediction image data as a result of inter prediction output from the inter prediction section 35 to the subtraction section 13 and also outputs information about the inter prediction to the lossless encoding section 16. The selector 27 switches the inter prediction mode and the intra prediction mode in accordance with the magnitude of a cost function value.

The intra prediction section 30 performs the intra prediction process based on the original image data input from the sorting buffer 11 and the decoded image data read from the frame memory 25. For example, the intra prediction section 30 evaluates prediction results obtained by candidate modes in a prediction mode set using a predetermined cost function. Then, the intra prediction section 30 selects a prediction mode having a smallest cost function value, that is, a prediction mode having a highest compression ratio as an optimal prediction mode. The intra prediction section 30 generates the prediction image data according to the optimal prediction mode. The intra prediction section 30 outputs the intra-prediction-related information including prediction mode information indicating a selected optimal prediction mode, the cost function value, and the prediction image data to the selector 27.

The inter prediction section 35 performs the inter prediction process based on the original image data input from the sorting buffer 11 and the decoded image data read from the frame memory 25. For example, the inter prediction section 35 evaluates prediction results obtained by candidate modes in a prediction mode set using a predetermined cost function. Then, the inter prediction section 35 selects a prediction mode having a smallest cost function value, that is, a prediction mode having a highest compression ratio, as an optimal prediction mode. The inter prediction section 35 generates the prediction image data according to the optimal prediction mode. The candidate mode set of the inter prediction may include the weighted prediction. The weighted prediction is executed by the weighted prediction section 45 which will be described later. The inter prediction section 35 outputs the inter-prediction-related information including the prediction mode information indicating the selected optimal prediction mode and motion information, the cost function value, and the prediction image data to the selector 27. When the weighted prediction is selected as the optimal prediction mode, the inter-prediction-related information may include the weighted prediction information.

The weighted prediction section 45 acquires the original image data and the decoded image data from the inter prediction section 35, and decides an optimal weighted prediction parameter. The weighted prediction parameter typically includes a weight and an offset of each reference frame. The weight and the offset may have different values for the luma component and the chroma component. The weighted prediction section 45 executes the weighted prediction using the decided optimal parameter, and generates a prediction image. The weighted prediction section 45 generates the weighted prediction information indicating the optimal parameter. The weighted prediction information generated by the weighted prediction section 45 may include weight denominator information indicating a denominator of a weight for the luma component and the chroma component. The weight denominator information has a code amount reduced to be smaller than information based on the known specification as will be further described later. Then, the weighted prediction section 45 outputs the generated prediction image and the weighted prediction information to the inter prediction section 35.

[2-2. Configuration Example of Bit Depth Control Section]

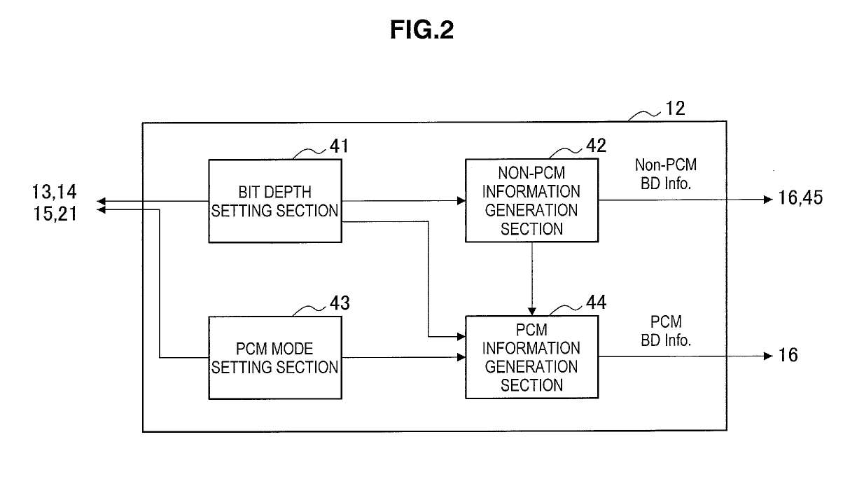

FIG. 2 is a block diagram showing an example of a detailed configuration of the bit depth control section 12 illustrated in FIG. 1. Referring to FIG. 2, the bit depth control section 12 includes a bit depth setting section 41, a non-PCM information generation section 42, a PCM mode setting section 43, and a PCM information generation section 44.

The bit depth setting section 41 sets bit depths for encoding the luma component and the chroma component of the non-PCM sample and the luma component and the chroma component of the PCM sample. For example, the bit depth setting section 41 may set the bit depths according to a setting value that is defined in advance or input by the user. For example, the bit depth setting section 41 may change the setting value of the bit depth according to a sequence. Then, the bit depth setting section 41 outputs the set bit depths to the non-PCM information generation section 42 and the PCM information generation section 44.

The non-PCM information generation section 42 generates the non-PCM bit depth information indicating the bit depth for encoding the luma component and the chroma component of the non-PCM sample input from the bit depth setting section 41. The non-PCM bit depth information includes the (non-PCM) luma bit depth information and the (non-PCM) chroma bit depth information. In the present embodiment, the luma bit depth information indicates a first bit depth for encoding the luma component. The chroma bit depth information indicates a second bit depth for encoding the chroma component using a bit depth difference between the first bit depth and the second bit depth. For example, when both the luma component and the chroma component are encoded using 8 bits, the bit depth difference indicated by the chroma bit depth information is equal to “0.” Similarly, even when both the luma component and the chroma component are encoded using 10 bits, the bit depth difference indicated by the chroma bit depth information is equal to “0.” The bit depth difference may be indicated by a single parameter such as a signed integer or may be indicated by a plurality of parameters corresponding to a sign and an absolute value. As a result, even when one of the bit depth of the luma component and the bit depth of the chroma component is large, it is possible to appropriately represent the bit depth of the chroma component.

The PCM mode setting section 43 sets whether or not encoding in a PCM mode is enabled in a series of image data (or in each sequence). For example, the PCM mode setting section 43 may set whether or not the PCM mode is enabled according to a setting value that is defined in advance or input by the user or based on prior video analysis. The PCM mode setting section 43 may change the setting for each sequence, for example. Then, the PCM mode setting section 43 outputs the setting result to the PCM information generation section 44.

The PCM information generation section 44 generates a flag indicating the setting result related to the PCM mode input from the PCM mode setting section 43. For example, the flag may indicate true when the encoding in the PCM mode is enabled and may indicate false when the encoding in the PCM mode is disabled.

When the encoding in the PCM mode is enabled, the PCM information generation section 44 further generates the PCM bit depth information indicating the bit depth for encoding the luma component and the chroma component of the PCM sample input from the bit depth setting section 41. The PCM bit depth information includes the PCM luma bit depth information, and the PCM chroma bit depth information. In the present embodiment, the PCM luma bit depth information indicates the bit depth difference between the non-PCM luma bit depth and the PCM luma bit depth. The PCM chroma bit depth is differentially encoded using the PCM luma bit depth and the bit depth difference indicated by the non-PCM chroma bit depth information. In other words, when the PCM chroma bit depth is assumed to be the sum of the PCM luma bit depth, the bit depth difference indicated by the non-PCM chroma bit depth information, and the remainder difference, the PCM chroma bit depth information indicates the remainder difference. Commonly, the non-PCM bit depth is higher in definition than the PCM bit depth. Thus, the PCM luma bit depth information may be indicated by a single parameter such as an unsigned integer. On the other hand, the PCM chroma bit depth information may be a single parameter such as a signed integer or may be indicated by a plurality of parameters corresponding to a sign and an absolute value.

The following Table 4 illustrates an example of a syntax of the bit depth information that can be generated according to the present embodiment. The syntax may be arranged, for example, in a portion of the SPS.

TABLE 4

| seq_parameter_set_rbsp( ){ | Descriptor |
|---|---|
| : | |
| bit_depth_luma_minus8 | ue(v) |
| delta_bit_depth_chroma | se(v) |
| : | |
| if(pcm_enabled_flag){ | |
| delta_pcm_sample_bit_depth_luma | s(4) |
| delta_pcm_sample_bit_depth_chroma | s(4) |
| : | |
| } | |
| : | |
| } | |

In Table 4, the parameter bit_depth_luma_minus8 corresponds to the (non-PCM) luma bit depth information, and indicates a value obtained by subtracting 8 from the non-PCM luma bit depth (is the same parameter as one shown in Table 1). A parameter delta_bit_depth_chroma corresponds to the (non-PCM) chroma bit depth information, and indicates the bit depth difference between the non-PCM luma bit depth and the non-PCM chroma bit depth.

The flag pcm_enabled_flag indicates whether or not the encoding in the PCM mode is enabled (is the same flag as one shown in Table 1). In Table 4, a parameter delta_pcm_sample_bit_depth_luma corresponds to the PCM luma bit depth information, and indicates the bit depth difference between the non-PCM luma bit depth and the PCM luma bit depth. A parameter delta_pcm_sample_bit_depth_chroma corresponds to the PCM chroma bit depth information, and indicates the remainder difference obtained by subtracting the PCM luma bit depth and the bit depth difference (between the non-PCM luma bit depth and the non-PCM chroma bit depth) from the PCM chroma bit depth.

According to the syntax shown in Table 4, the non-PCM luma bit depth bit_depth_luma and the non-PCM chroma bit depth bit_depth_chroma have a relation expressed by the following Formulas (1) and (2) with the non-PCM bit depth information:

[Math 1]

bit_depth_luma=bit_depth_luma_minus8+8 (1)

bit_depth_chroma=bit_depth_luma+delta_bit_depth_chroma (2)

Further, according to the syntax shown in Table 4, the PCM luma bit depth pcm_bit_depth_luma and the PCM chroma bit depth pcm_bit_depth_chroma have a relation expressed by the following Formulas (3) and (4) with the non-PCM bit depth information and the PCM bit depth information.

[Math 2]

pcm_bit_depth_luma=bit_depth_luma+delta_pcm_sample_bit_depth_luma (3)

pcm_bit_depth_chroma=pcm_bit_depth_luma+delta_bit_depth_chroma+delta_pcm_sample_bit_depth_chroma (4)

Embodiments are not limited to the above-described example, and the PCM chroma bit depth information may indicate the bit depth difference obtained by subtracting only the PCM luma bit depth from the PCM chroma bit depth. In this case, a second term on the right side of Formula (4) is omitted.

The non-PCM information generation section 42 outputs the non-PCM bit depth information (Non-PCM BD Information) that can be generated by the above-described technique to the lossless encoding section 16 and the weighted prediction section 45. The PCM information generation section 44 outputs the PCM bit depth information (PCM BD Information) that can be obtained by the above-described technique to the lossless encoding section 16. The lossless encoding section 16 encodes the bit depth information including the non-PCM bit depth information and the PCM bit depth information.

In a modified example, the bit depth setting section 41 may set different bit depths for different coding unit (CU) sizes. The CU size is set to be small when an image region includes many frequency components. For an image region in which a large CU size is set because many frequency components are included, even when the PCM bit depth is relatively low, that is, even when an expressible gradation is coarse, deterioration in an image quality is considered not to be detected accordingly. Thus, when different bit depths can be used for different CU sizes, it is possible to suppress a rate of the PCM sample by variably controlling the bit depth for each image region. In this modified example, the PCM information generation section 44 generates the PCM bit depth information indicating different bit depth differences according to a CU size (for example, a pair of parameters delta_pcm_sample_bit_depth_luma and delta_pcm_sample_bit_depth_chroma shown in Table 4 can be provided by the number of CU size candidates. A bit depth difference for a certain CU size included in the PCM bit depth information may be differentially encoded based on a bit depth difference for another CU size. As a result, in the present modified example, it is possible to reduce the code amount of the PCM bit depth information.

[2-3. Configuration Example of Weighted Prediction Section]

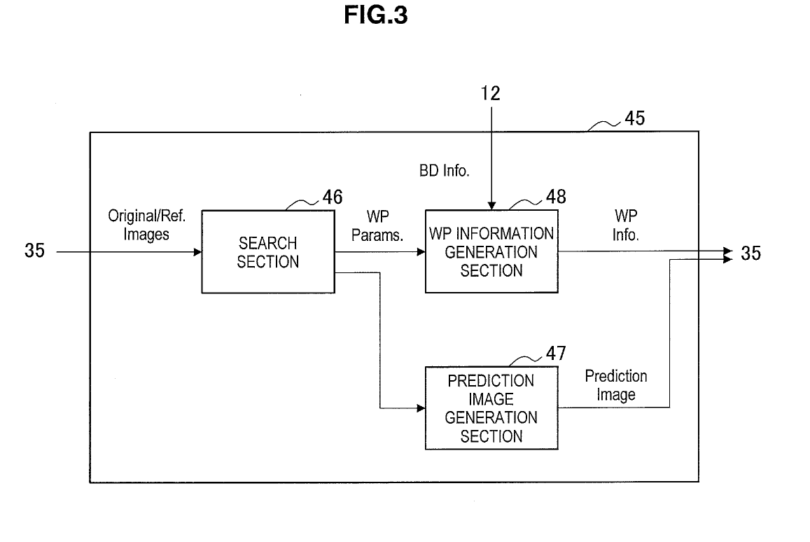

FIG. 3 is a block diagram showing an example of a detailed configuration of the weighted prediction section 45 illustrated in FIG. 1. Referring to FIG. 3, the weighted prediction section 45 includes a search section 46, a prediction image generation section 47, and a weighted prediction (WP) information generation section 48.

The search section 46 decides optimal weighted prediction parameters (WP parameters) for predicting an image of a prediction target block, that is, a weight and offset of each reference frame based on the original image data of the prediction target block (typically, a prediction unit (PU)) and the decoded image data. Then, the search section 46 outputs the decided weighted prediction parameter to the prediction image generation section 47 and the WP information generation section 48.

The prediction image generation section 47 executes the weighted prediction by applying the weighted prediction parameter input from the search section 46 to the respective reference frames, and generates the prediction image of the prediction target block. Then, the prediction image generation section 47 outputs the generated prediction image to the inter prediction section 35.

The WP information generation section 48 generates the weighted prediction information (WP Information) indicating the optimal weighted prediction parameter decided by the search section 46. For example, the weighted prediction information may indicate the denominator of the weight, the numerator of the weight, and the offset that are applied to the luma component of each reference frame and the denominator of the weight, the numerator of the weight, and the offset that are applied to the chroma component of each reference frame. For example, first weight denominator information indicating the denominator of the weight of the luma component may be a logarithmic parameter luma_log 2 weight_denom shown in Table 3. On the other hand, in the present embodiment, the denominator of the weight of the chroma component is differentially encoded using the bit depth difference between the luma component and the chroma component input from the bit depth control section 12. In other words, when a logarithm (to base 2) of the denominator of the weight of the chroma component is assumed to be the sum of a logarithm of the denominator of the weight of the luma component, the bit depth difference between the luma component and the chroma component, and the remainder difference, second weight denominator information indicates the remainder difference. The numerator of the weight and the offset may be indicated by the same information as the known parameters shown in Table 3.

The syntax of the weighted prediction information that can be generated according to the present embodiment may be basically the same as the syntax shown in Table 3. However, the meaning of the logarithmic parameter delta_chroma_log 2_weight_denom included in the syntax is defined again. The denominator luma_weight_denom of the weight of the luma component and the denominator chroma_weight_denom of the weight of the chroma component have a relation expressed by the following Formulas (5) and (6) with the first weight denominator information luma_log 2_weight_denom and the second weight denominator information delta_chroma_log 2_weight_denom:

[Math 3]

log₂(luma_weight_denom)=luma_log 2_weight_denom (5)

log₂(chroma_weight_denom)=luma_log 2_weight_denom+delta_bit_depth_chroma+delta_chroma_log 2_weight_denom (6)

The WP information generation section 48 outputs the weighted prediction information that can be generated based on the above relational expression to the inter prediction section 35. When the weighted prediction is selected as the prediction mode, the lossless encoding section 16 encodes the weighted prediction information (including the first weight denominator information and the second weight denominator information) input from the inter prediction section 35.

As described above, in the present embodiment, the code amount of various types of bit-depth-related information is reduced using the differential encoding technique. For example, when the luma bit depth is equal to the chroma bit depth, the parameter value of the chroma bit depth information becomes zero. When the non-PCM luma bit depth is equal to the PCM luma bit depth, the parameter value of the PCM luma bit depth information becomes zero. The parameter value of the weight denominator information is also lowered to zero or a value closer to zero using a correlation between the denominator of the weight of the weighted prediction and the bit depth. Commonly, a length of a code word allocated to zero or a value closer to zero through variable length coding is small. Thus, in the present embodiment, it is possible to increase the coding efficiency as a result of avoiding the redundant coding of the bit-depth-related information. Further, when the present embodiment is implemented, some features described above may not be implemented. For example, even when one of differential encoding of a bit depth between color components and differential encoding of a bit depth of the non-PCM sample/PCM sample is implemented, the effect of improving the coding efficiency can be obtained.

### 3. PROCESS FLOW FOR ENCODING ACCORDING TO AN EMBODIMENT

[3-1. Schematic Flow]

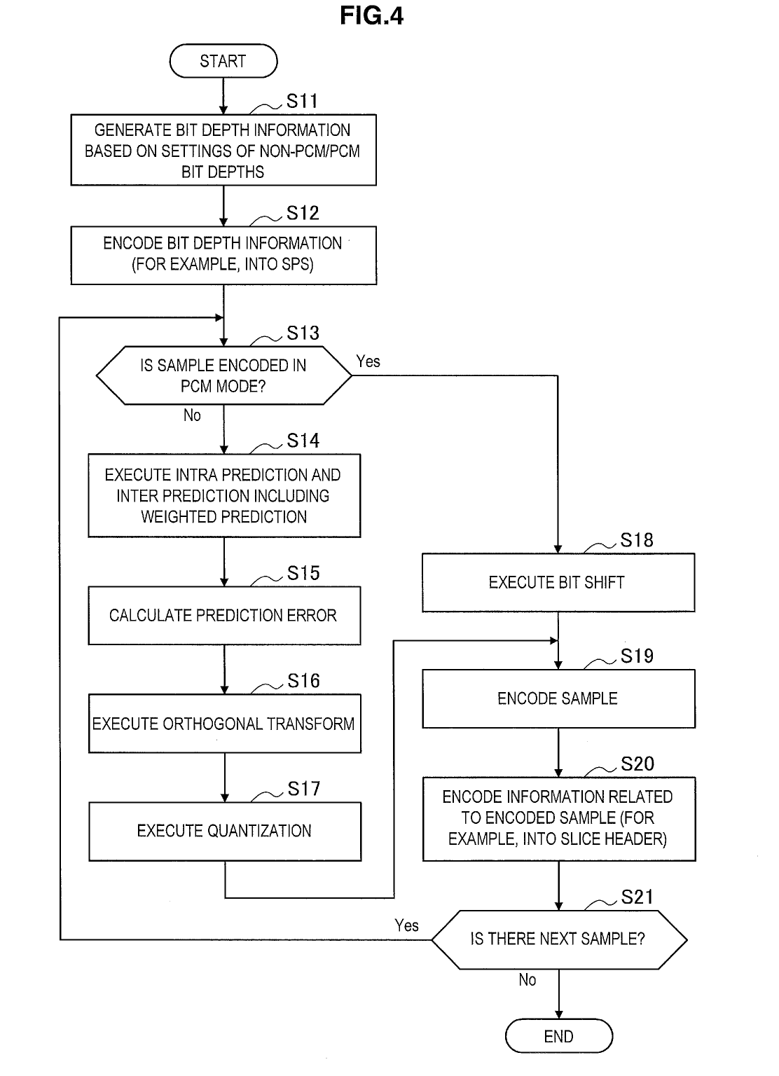

FIG. 4 is a flow chart showing an example of a schematic process flow for encoding according to an embodiment. For the sake of brevity of description, process steps that are not directly related to technology according to the present disclosure are omitted from FIG. 4.

Referring to FIG. 4, first, the bit depth control section 12 generates the bit depth information based on the settings of the bit depth of the luma component and the chroma component of the non-PCM, and the bit depth of the luma component and the chroma component of the PCM (step S11). The bit depth information generated herein may have the syntax including the non-PCM bit depth information and the PCM bit depth information shown in Table 4, for example. Then, the bit depth control section 12 outputs the non-PCM bit depth information and the PCM bit depth information to the lossless encoding section 16.

Then, the lossless encoding section 16 encodes the bit depth information generated by the bit depth control section 12, and inserts the encoded bit depth information, for example, into the SPS of the encoded stream (step S12). The subsequent process is repeated for each of samples included in one or more pictures in a sequence.

First, the bit depth control section 12 determines whether or not the sample is encoded in the PCM mode (step S13). When the sample is not encoded in the PCM mode (that is, when the sample is encoded in the non-PCM mode), the intra prediction and the inter prediction are executed on the sample through the intra prediction section 30 and the inter prediction section 35, and the prediction image of the optimal prediction mode is generated (step S14). The inter prediction executed herein includes the weighted prediction performed by the weighted prediction section 45. For an I slice, the execution of the inter prediction is skipped. Then, the subtraction section 13 calculates the prediction error of the non-PCM sample by subtracting the prediction image from the original image (step S15). Then, the orthogonal transform section 14 generates the transform coefficient data by performing the orthogonal transform on the prediction error of the non-PCM sample (step S16). Then, the quantization section 15 generates the quantized data of the non-PCM sample by quantizing the transform coefficient data (step S17).

On the other hand, when the sample is determined to be encoded in the PCM mode in step S13, the quantization section 15 executes the bit shift on the original image of the PCM sample, and generates the quantized data of the PCM sample (step S18).

Then, the lossless encoding section 16 encodes the quantized data of the non-PCM sample or the PCM sample generated by the quantization section 15, and generates the encoded stream (step S19). Further, the lossless encoding section 16 encodes information related to the encoded sample, and inserts the encoded information into the header region of the encoded stream (step S20). For example, the weighted prediction information generated by the weighted prediction section 45 may be inserted into the slice header.

Thereafter, when there is a sample to be processed, the process proceeds to step S13 (step S21). When there is no sample to be processed, the flowchart illustrated in FIG. 4 ends.

[3-2. Bit Depth Information Generation Process]

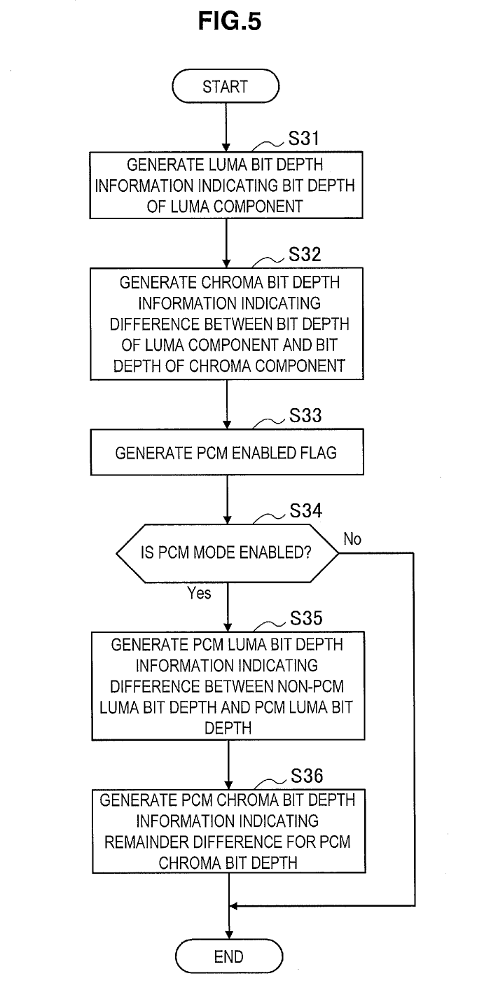

FIG. 5 is a flowchart showing an example of the flow of a bit depth information generation process according to an embodiment. The bit depth information generation process illustrated in FIG. 5 may be executed by the bit depth control section 12, for example, in step S11 of FIG. 4.

Referring to FIG. 5, first, the non-PCM information generation section 42 of the bit depth control section 12 generates the luma bit depth information (for example, the parameter bit_depth_luma_minus8) indicating the bit depth of the luma component of the non-PCM (step S31).

Then, the non-PCM information generation section 42 generates the chroma bit depth information (for example, the parameter delta_bit_depth_chroma) indicating the bit depth difference between the bit depth of the luma component and the bit depth of the chroma component of the non-PCM (step S32).

Then, the PCM information generation section 44 generates a PCM enabled flag (for example, the flag pcm_enabled_flag) indicating whether or not the encoding in the PCM mode is enabled according to a setting performed by the PCM mode setting section 43 (step S33). The subsequent process is executed only when the encoding in the PCM mode is enabled (step S34).

When the encoding in the PCM mode is enabled, the PCM information generation section 44 generates the PCM luma bit depth information (for example, the parameter delta_pcm_sample_bit_depth_luma) indicating the bit depth difference between the non-PCM luma bit depth and the PCM luma bit depth (step S35).

Then, the PCM information generation section 44 generates the PCM chroma bit depth information (for example, the parameter delta_pcm_sample_bit_depth_chroma) indicating the remainder difference (that is, the remainder difference calculated by subtracting the PCM luma bit depth and the bit depth difference calculated in step S32 from the PCM chroma bit depth) for the PCM chroma bit depth (step S36).

[3-3. WP Information Generation Process]

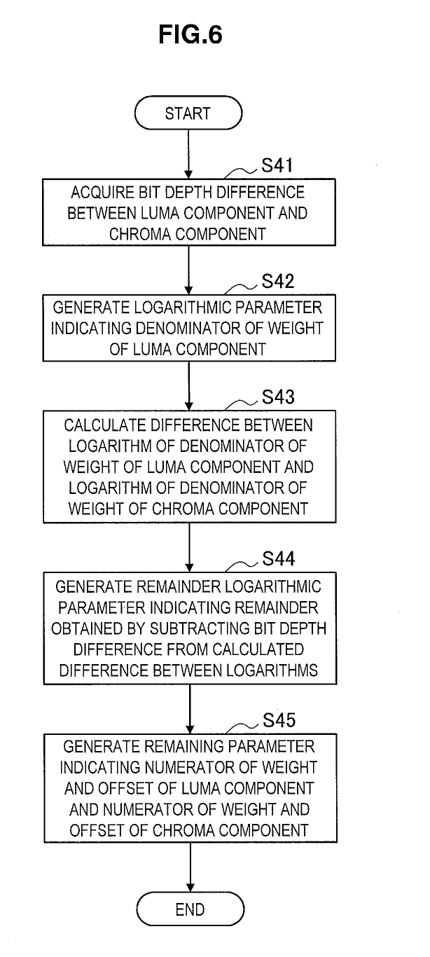

FIG. 6 is a flowchart showing an example of the flow of a WP information generation process according to an embodiment. The WP information generation process illustrated in FIG. 6 may be executed by the weighted prediction section 45, for example, in step S14 of FIG. 4.

Referring to FIG. 6, first, the WP information generation section 48 of the weighted prediction section 45 acquires the bit depth difference between the luma component and the chroma component from the bit depth control section 12 (step S41).

Then, the WP information generation section 48 generates the first weight denominator information (for example, the logarithmic parameter luma_log 2_weight_denom) indicating the denominator of the weight of the luma component decided by the search section 46 (step S42).

Then, the WP information generation section 48 calculates a difference between the logarithm (to base 2) of the denominator of the weight of the luma component and the logarithm of the denominator of the weight of the chroma component decided by the search section 46 (step S43).

Then, the WP information generation section 48 generates the second weight denominator information (for example, the remainder logarithmic parameter delta_chroma_log 2_weight_denom) indicating the remainder obtained by subtracting the bit depth difference acquired in step S41 from the calculated difference between the logarithms (step S44).

Then, the WP information generation section 48 generates the remaining weighted prediction parameter indicating the numerator of the weight and the offset of the luma component and the numerator of the weight and the offset of the chroma component (step S45).

### 4. EXAMPLE OF CONFIGURATION OF IMAGE DECODING DEVICE ACCORDING TO EMBODIMENT

[4-1. Overall Configuration Example]

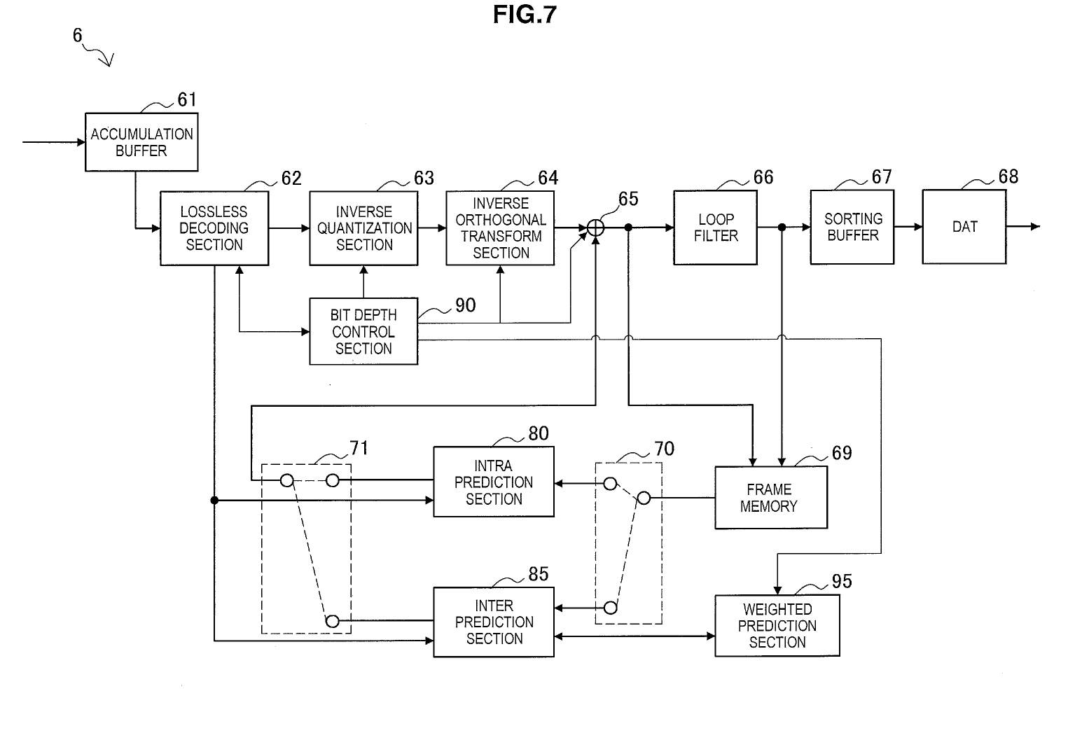

FIG. 7 is a block diagram showing an example of a configuration of an image decoding device 6 according to an embodiment. Referring to FIG. 7, the image decoding device 6 includes an accumulation buffer 61, a lossless decoding section 62, an inverse quantization section 63, an inverse orthogonal transform section 64, an addition section 65, a loop filter 66, a sorting buffer 67, a digital-to-analog (D/A) conversion section 68, a frame memory 69, selectors 70 and 71, an infra prediction section 80, an inter prediction section 85, a bit depth control section 90, and a weighted prediction section 95.

The accumulation buffer 61 temporarily accumulates the encoded stream input via a transmission path using a storage medium.

The lossless decoding section 62 decodes the quantized data from the encoded stream accumulated by the accumulation buffer 61 according to the encoding scheme used at the time of encoding. The luma component and the chroma component of the non-PCM sample and the luma component and the chroma component of the PCM sample are decoded according to the bit depths indicated by the bit depth information. The lossless decoding section 62 outputs the quantized data to the inverse quantization section 63. The lossless decoding section 62 decodes information inserted into the header region of the encoded stream. For example, the bit depth information is decoded from the SPS and output to the bit depth control section 90. The intra-prediction-related information is output to the infra prediction section 80. The inter-prediction-related information is output to the inter prediction section 85. The inter-prediction-related information may include the weighted prediction information.

The bit depth control section 9 sets various types of bit depths related to the decoding process in the image decoding device 6 according to the bit depth information decoded by the lossless decoding section 62. The bit depth control section 90 controls the bit depth of the decoded image data according to a corresponding setting. The bit depth information includes at least the luma bit depth information and the chroma bit depth information. When the PCM coding is enabled, the bit depth information may further include the PCM luma bit depth information and the PCM chroma bit depth information. The bit depth information has the code amount reduced based on the technique described above. The bit depth control section 90 may output the chroma bit depth information to the weighted prediction section 95.

The inverse quantization section 63 inversely quantizes the quantized data of the non-PCM sample using the same quantization step as one used at the time of encoding, and restores the transform coefficient data of the non-PCM sample. Further, the inverse quantization section 63 inversely quantizes the quantized data of the PCM sample by performing the bit shift by the same shift amount as one used at the time of encoding, and restores the image data of the PCM sample. The inverse quantization section 63 outputs the restored transform coefficient data or image data to the inverse orthogonal transform section 64.

The inverse orthogonal transform section 64 generates the prediction error data by performing the inverse orthogonal transform on the transform coefficient data of the non-PCM sample input from the inverse quantization section 63 according to the orthogonal transform scheme used at the time of encoding. Then, the inverse orthogonal transform section 64 outputs the prediction error data of the non-PCM sample to the addition section 65. For the PCM sample, the bit depth control section 90 skips the execution of the inverse orthogonal transform process by the inverse orthogonal transform section 64. In this case, the inverse orthogonal transform section 64 outputs the image data of the PCM sample without change.

The addition section 65 reconstructs the decoded image data of the non-PCM sample by adding the prediction error data of the non-PCM sample input from the inverse orthogonal transform section 64 to the prediction image data input from the selector 71. Then, the addition section 65 outputs the decoded image data of the non-PCM sample to the loop filter 66 and the frame memory 69. For the PCM sample, the bit depth control section 90 skips the addition of the prediction error data by the addition section 65. In this case, the addition section 65 outputs the image data (the decoded image data) of the PCM sample without change.

The loop filter 66 includes a deblock filter that reduces block distortion and a sample adaptive offset (SAO) filter that adds an offset value to each pixel value, similarly to the loop filter 24 of the image encoding device 1. The loop filter 66 filters the decoded image data input from the addition section 65, and outputs the filtered decoded image data to the sorting buffer 67 and the frame memory 69.

The sorting buffer 67 sorts the images input from the loop filter 66 to generate a chronological series of image data. Then, the sorting buffer 67 outputs the generated image data to the D/A conversion section 68.

The D/A conversion section 68 converts the image data with a digital format input from the sorting buffer 67 into an image signal with an analog format. Then, the D/A conversion section 68 displays the image by outputting the analog image signal to, for example, a display (not shown) connected to the image decoding device 6.

The frame memory 69 stores the decoded image data before the filtering input from the addition section 65, and the decoded image data after the filtering input from the loop filter 66 using a storage medium.

The selector 70 switches an output destination of the image data from the frame memory 69 between the intra prediction section 80 and the inter prediction section 85 for each block in the image according to the mode information acquired by the lossless decoding section 62. For example, when the intra prediction mode is designated, the selector 70 outputs the decoded image data before the filtering supplied from the frame memory 69 as the reference image data to the intra prediction section 80. When the inter prediction mode is designated, the selector 70 outputs the decoded image data after the filtering as the reference image data to the inter prediction section 85.

The selector 71 switches an output source of the prediction image data to be supplied to the addition section 65 between the intra prediction section 80 and the inter prediction section 85 according to the mode information acquired by the lossless decoding section 62. For example, when the intra prediction mode is designated, the selector 71 supplies the prediction image data output from the intra prediction section 80 to the addition section 65. When the inter prediction mode is designated, the selector 71 supplies the prediction image data output from the inter prediction section 85 to the addition section 65.

The intra prediction section 80 generates the prediction image data by executing the intra prediction based on the intra-prediction-related information input from the lossless decoding section 62 and the reference image data input from the frame memory 69. The intra prediction section 80 outputs the generated prediction image data to the selector 71.

The inter prediction section 85 generates the prediction image data by executing the inter prediction based on the inter-prediction-related information input from the lossless decoding section 62 and the reference image data input from the frame memory 69. When the prediction mode of the inter prediction indicates the weighted prediction, the inter prediction section 85 causes the weighted prediction section 95 to execute the weighted prediction. In this case, the inter prediction section 85 outputs the reference image data and the weighted prediction information to the weighted prediction section 95. Then, the inter prediction section 85 outputs the generated prediction image data to the selector 71.

The weighted prediction section 95 acquires the decoded image data and the weighted prediction information from the inter prediction section 85, and generates the prediction image by executing the weighted prediction according to the weighted prediction parameter reconstructed from the weighted prediction information. The weighted prediction parameter includes a weight and the offset of each reference frame as described above. The weight and the offset may have different values for the luma component and the chroma component. Then, the weighted prediction section 95 outputs the generated prediction image to the inter prediction section 85.

[4-2. Configuration Example of Bit Depth Control Section]

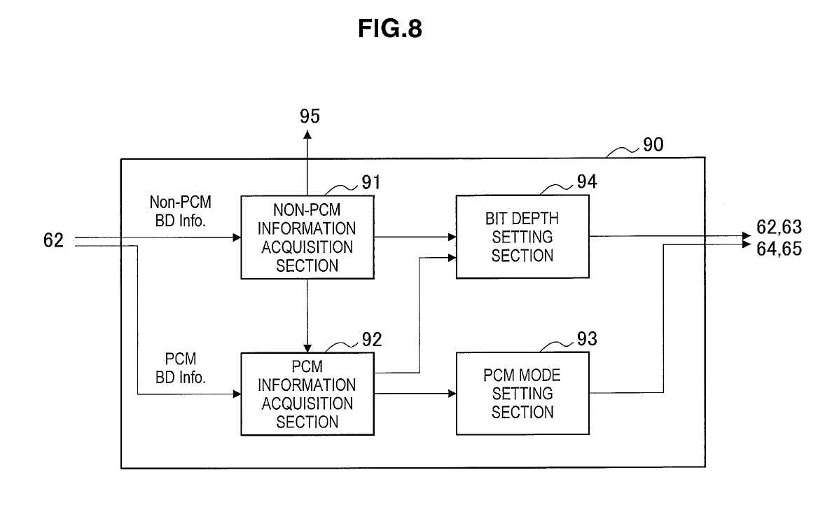

FIG. 8 is a block diagram showing an example of a detailed configuration of the bit depth control section 90 illustrated in FIG. 7. Referring to FIG. 8, the bit depth control section 90 includes a non-PCM information acquisition section 91, a PCM information acquisition section 92, a PCM mode setting section 93, and a bit depth setting section 94.

The non-PCM information acquisition section 91 acquires the non-PCM bit depth information decoded by the lossless decoding section 62. The bit depth information acquired herein includes the luma bit depth information for decoding the encoded luma component of the image and the chroma bit depth information for decoding the chroma component of the image. The chroma bit depth information indicates the bit depth difference between the luma bit depth and the chroma bit depth. For example, the luma bit depth information may correspond to the parameter bit_depth_luma_minus8 in Table 4. The chroma bit depth information may correspond to the parameter delta_bit_depth_chroma in Table 4. The non-PCM information acquisition section 91 calculates the chroma bit depth by adding (or subtracting) the bit depth difference indicated by the chroma bit depth information to (or from) the luma bit depth indicated by the luma bit depth information, for example, according to Formula (2). Then, the non-PCM information acquisition section 91 outputs the luma bit depth and the chroma bit depth of the non-PCM to the bit depth setting section 94.

The PCM information acquisition section 92 acquires the PCM bit depth information decoded by the lossless decoding section 62. The PCM bit depth information includes at least the PCM enabled flag (for example, the flag pcm_enabled_flag in Table 4) indicating whether or not the encoding in the PCM mode is enabled. The PCM information acquisition section 92 outputs the PCM enabled flag to the PCM mode setting section 93.

When the PCM enabled flag indicates that the encoding in the PCM mode is enabled, the PCM bit depth information acquired by the PCM information acquisition section 92 further includes the PCM bit depth information for decoding the PCM sample of the encoded image. The PCM bit depth information includes the PCM luma bit depth information and the PCM chroma bit depth information. The PCM luma bit depth information indicates the bit depth difference between the non-PCM luma bit depth indicated by the non-PCM bit depth information and the PCM luma bit depth. The PCM chroma bit depth information indicates the remainder difference related to the PCM chroma bit depth. For example, the PCM luma bit depth information may correspond to the parameter delta_pcm_sample_bit_depth_luma in Table 4. The PCM chroma bit depth information may correspond to the parameter delta_pcm_sample_bit_depth_chroma in Table 4. The PCM information acquisition section 92 calculates the PCM luma bit depth by adding (or subtracting) the bit depth difference indicated by the PCM luma bit depth information to (or from) the non-PCM luma bit depth, for example, according to Formula (3). Further, the PCM information acquisition section 92 calculates the PCM chroma bit depth by adding (or subtracting) the bit depth difference indicated by the non-PCM chroma bit depth information and the remainder difference indicated by the PCM chroma bit depth information to (from) the PCM luma bit depth, for example, according to Formula (4). Then, the PCM information acquisition section 92 outputs the luma bit depth and the chroma bit depth of the PCM to the bit depth setting section 94.

The PCM mode setting section 93 enables or disables the decoding in the PCM mode in the image decoding device 6 according to the PCM enabled flag input from the PCM information acquisition section 92. For example, when the decoding in the PCM mode is enabled, and the PCM sample is decoded, the PCM mode setting section 93 causes the inverse quantization section 63 to perform the bit shift on the quantized data and restore the image data, and skips the inverse orthogonal transform process in the inverse orthogonal transform section 64 and the addition of the prediction error in the addition section 65. When the decoding in the PCM mode is disabled, the sequence includes no PCM sample.

The bit depth setting section 94 sets the luma bit depth and the chroma bit depth of the non-PCM input from the non-PCM information acquisition section 91 and the luma bit depth and the chroma bit depth of the PCM input from the PCM information acquisition section 92 in order to decode the image. In response to the setting, the image decoding device 6 decodes the luma component of the non-PCM sample according to the non-PCM luma bit depth, and decodes the chroma component of the non-PCM sample according to the non-PCM chroma bit depth. Further, the image decoding device 6 decodes the luma component of the PCM sample according to the PCM luma bit depth, and decodes the chroma component of the PCM sample according to the PCM chroma bit depth.

In a modified example, the PCM bit depth information may include a parameter indicating a different bit depth difference according to a CU size, and the bit depth setting section 94 may set a different bit depth according to a CU size. As a result, it is possible to suppress the rate of the PCM sample by variably controlling the bit depth for each image region. For example, the PCM bit depth information may include a pair of parameters delta_pcm_sample_bit_depth_luma and delta_pcm_sample_bit_depth_chroma shown in Table 4 by the number of CU size candidates. A bit depth difference for a certain CU size in the PCM bit depth information may be differentially encoded based on a bit depth difference for another CU size. As a result, in the present modified example, it is possible to reduce the code amount of the PCM bit depth information.

[4-3. Configuration Example of Weighted Prediction Section]

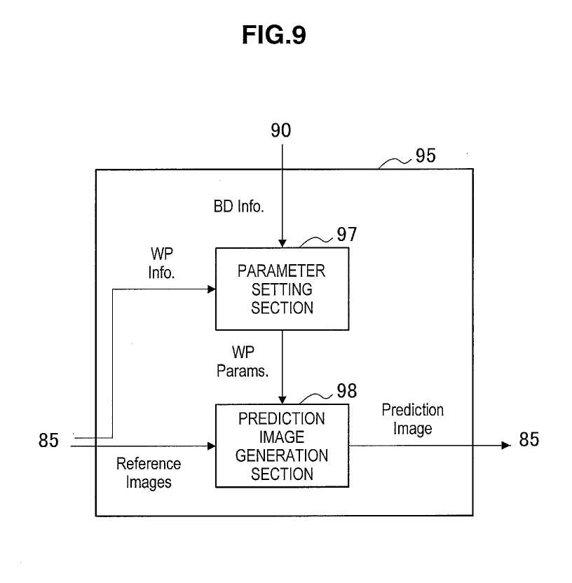

FIG. 9 is a block diagram showing an example of a detailed configuration of the weighted prediction section 95 illustrated in FIG. 7. Referring to FIG. 9, the weighted prediction section 95 includes a parameter setting section 97 and a prediction image generation section 98.

When the weighted prediction is designated as the prediction mode of the inter prediction, the parameter setting section 97 acquires the weighted prediction information decoded by the lossless decoding section 62. For example, the weighted prediction information acquired herein may indicate the denominator of the weight, the numerator of the weight, and the offset which are applied to the luma component of each reference frame and the denominator of the weight, the numerator of the weight, and the offset which are applied to the chroma component of each reference frame. For example, the first weight denominator information indicating the denominator of the weight of the luma component indicates the denominator of the weight of the luma component by the logarithm to the base 2. For example, the second weight denominator information indicating the denominator of the weight of the chroma component indicates the remainder (of the logarithm of the denominator) related to the denominator of the weight of the chroma component. Then, the parameter setting section 97 calculates the denominator of the weight of the chroma component based on the logarithm of the denominator of the weight of the luma component indicated by the first weight denominator information, the bit depth difference between the luma component and the chroma component input from the bit depth control section 90, and the remainder difference indicated by the second weight denominator information. For example, the weighted prediction information may have the syntax shown in Table 3. For example, the first weight denominator information may correspond to the logarithmic parameter luma_log 2_weight_denom, and the second weight denominator information may correspond to the logarithmic parameter delta_chroma_log 2_weight_denom. However, the meaning of the logarithmic parameter delta_chroma_log 2_weight_denom is defined again to indicate the remainder logarithm as described above using Formula (6). Then, the parameter setting section 97 sets the weighted prediction parameter (a weight and the offset of each color component of each reference frame) reconstructed from the weighted prediction information to the prediction target block.

The prediction image generation section 98 executes the weighted prediction by applying the weighted prediction parameter set by the parameter setting section 97 to the respective reference frames, and generates the prediction image of the prediction target block. Then, the prediction image generation section 98 outputs the generated prediction image to the inter prediction section 85.

### 5. PROCESS FLOW FOR DECODING ACCORDING TO AN EMBODIMENT

[5-1. Schematic Flow]

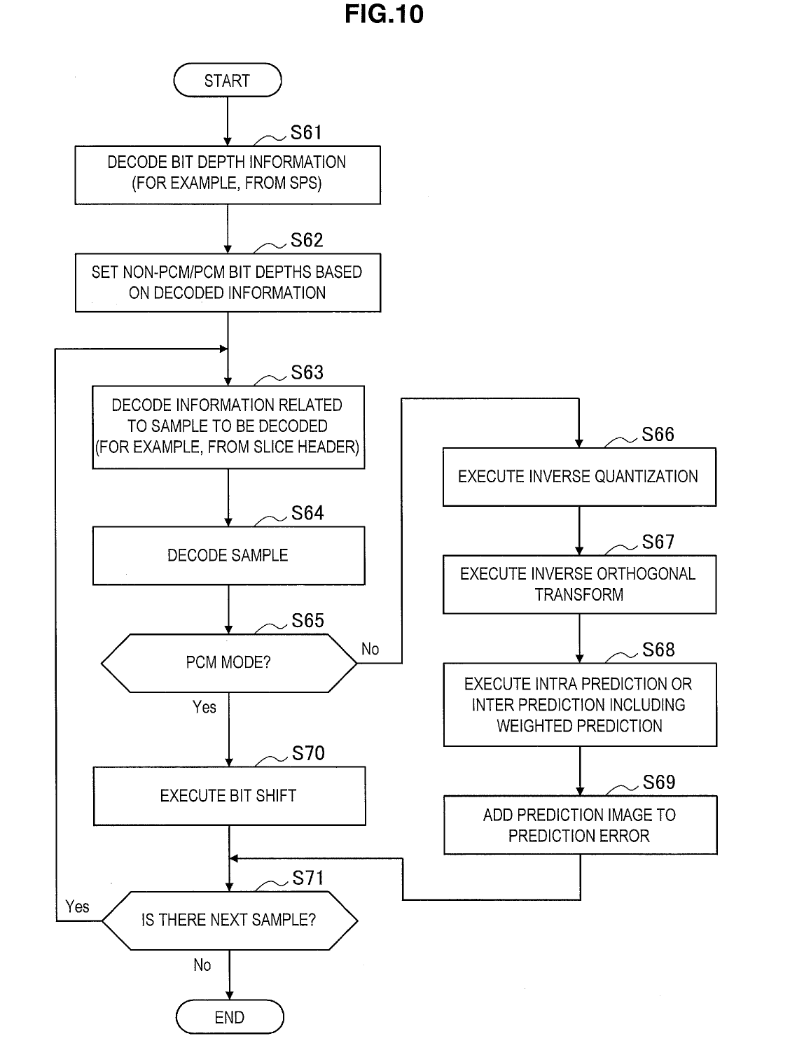

FIG. 10 is a flow chart showing an example of a schematic process flow at the time of the decoding according to an embodiment. For the sake of brevity of description, process steps not directly relevant to the technology in the present disclosure are omitted from the drawing.

Referring to FIG. 10, first, the lossless decoding section 62 decodes the bit depth information, for example, the SPS of the encoded stream (step S61). The bit depth information decoded herein includes the non-PCM bit depth information and the PCM bit depth information. Then, the lossless decoding section 62 outputs the decoded bit depth information to the bit depth control section 90.

Then, the bit depth control section 90 sets the bit depth of the luma component and the chroma component of the non-PCM and the bit depth of the luma component and the chroma component of the PCM based on the bit depth information decoded by the lossless decoding section 62 (step S62). The subsequent process is repeated for each of the samples included in one or more pictures in the sequence.

First, the lossless decoding section 62 decodes information related to a sample to be decoded, for example, from the slice header (step S63). The information decoded herein may include the prediction mode information and the weighted prediction information when the weighted prediction is designated by the prediction mode information. The lossless decoding section 62 decodes the quantized data of the non-PCM sample or the PCM sample (step S64).

Then, the bit depth control section 90 determines whether or not the sample is decoded in the PCM mode (step S65). When the sample is not decoded in the PCM mode (that is, when the sample is decoded in the non-PCM mode), the inverse quantization section 63 inversely quantizes the quantized data of the non-PCM sample, and restores the transform coefficient data (step S66). The inverse orthogonal transform section 64 executes the inverse orthogonal transform on the transform coefficient data of the non-PCM sample, and generates the prediction error data (step S67). Further, when the intra prediction mode is designated, the intra prediction section 80 executes the intra prediction, and when the inter prediction mode is designated, the inter prediction section 85 executes the inter prediction (step S68). As a result, the prediction image is generated. The inter prediction executed herein may include the weighted prediction performed by the weighted prediction section 95. Then, the addition section 65 reconstructs the decoded image data of the non-PCM sample by adding the prediction error of the non-PCM sample to the prediction image (step S69).

On the other hand, when the sample is determined to be decoded in the PCM mode in step S65, the inverse quantization section 63 inversely quantizes the quantized data of the PCM sample by performing the bit shift, and reconstructs the image data of the PCM sample (step S70).

Thereafter, when there is a sample to be processed, the process proceeds to step S63 (step S71). When there is no sample to be processed, the flowchart illustrated in FIG. 10 ends.

[5-2. Bit Depth Calculation Process]

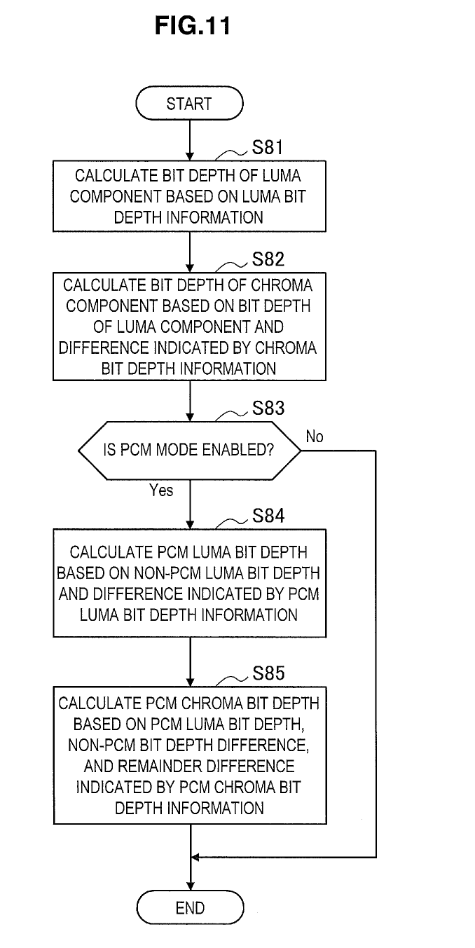

FIG. 11 is a flowchart showing an example of the flow of a bit depth calculation process according to an embodiment. The bit depth calculation process illustrated in FIG. 11 may be executed by the bit depth control section 90, for example, in step S62 of FIG. 10.

Referring to FIG. 11, first, the non-PCM information acquisition section 91 of the bit depth control section 90 calculates the non-PCM luma bit depth based on the luma bit depth information, for example, according to Formula (1) (step S81).

Then, the non-PCM information acquisition section 91 calculates the non-PCM chroma bit depth based on the non-PCM luma bit depth calculated in step S81 and the bit depth difference indicated by the chroma bit depth information, for example, according to Formula (2) (step S82).

Then, the PCM information acquisition section 92 determines whether or not the PCM enabled flag included in the PCM bit depth information indicates that the decoding in the PCM mode is enabled (step S83). When the PCM enabled flag indicates that the decoding in the PCM mode is enabled, the subsequent process is executed.

When the decoding in the PCM mode is enabled, the PCM information acquisition section 92 calculates the PCM luma bit depth based on the non-PCM luma bit depth and the bit depth difference indicated by the PCM luma bit depth information, for example, according to Formula (3) (step S84).

Then, the PCM information acquisition section 92 calculates the PCM chroma bit depth based on the PCM luma bit depth, the bit depth difference indicated by the non-PCM chroma bit depth information, and the remainder difference indicated by the PCM chroma bit depth information, for example, according to Formula (4) (step S85).

[5-3. WP Parameter Calculation Process]

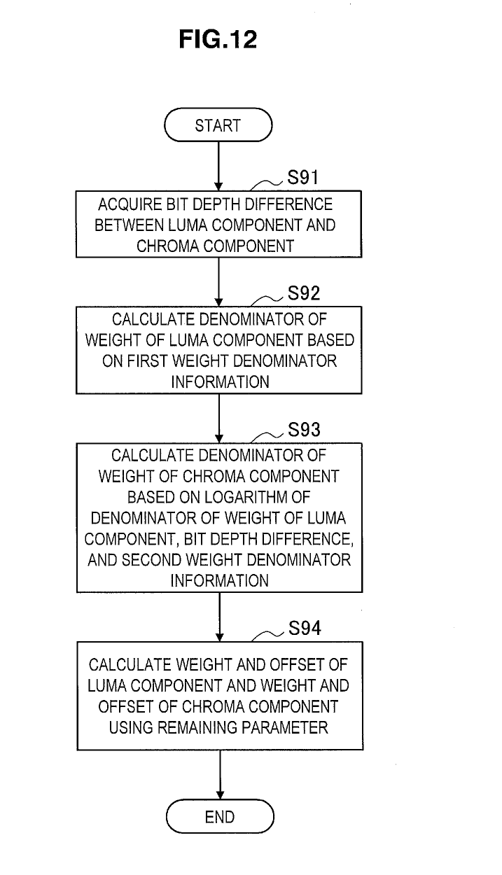

FIG. 12 is a flowchart showing an example of the flow of a WP parameter calculation process according to an embodiment. The WP parameter calculation process illustrated in FIG. 12 may be executed by the weighted prediction section 95, for example, in step S68 of FIG. 10.

Referring to FIG. 12, first, the parameter setting section 97 of the weighted prediction section 95 acquires the bit depth difference between the luma component and the chroma component from the bit depth control section 90 (step S91).

Then, the parameter setting section 97 calculates the denominator of the weight of the luma component based on the first weight denominator information included in the weighted prediction information, for example, according to Formula (5) (step S92).

Then, the parameter setting section 97 calculates the denominator of the weight of the chroma component based on the logarithm of the denominator of the weight of the luma component, the bit depth difference acquired in step S91, and the remainder difference indicated by the second weight denominator information, for example, according to Formula (6) (step S93).

Then, the parameter setting section 97 calculates the weight and the offset of the luma component and the weight and the offset of the chroma component using the remaining parameter included in the weighted prediction information (step S94).

The calculation of step S92 to step S93 illustrated in FIG. 12 may be repeated for each reference frame.

### 6. EXAMPLE APPLICATION

The image encoding device 1 and the image decoding device 6 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### (1) First Application Example

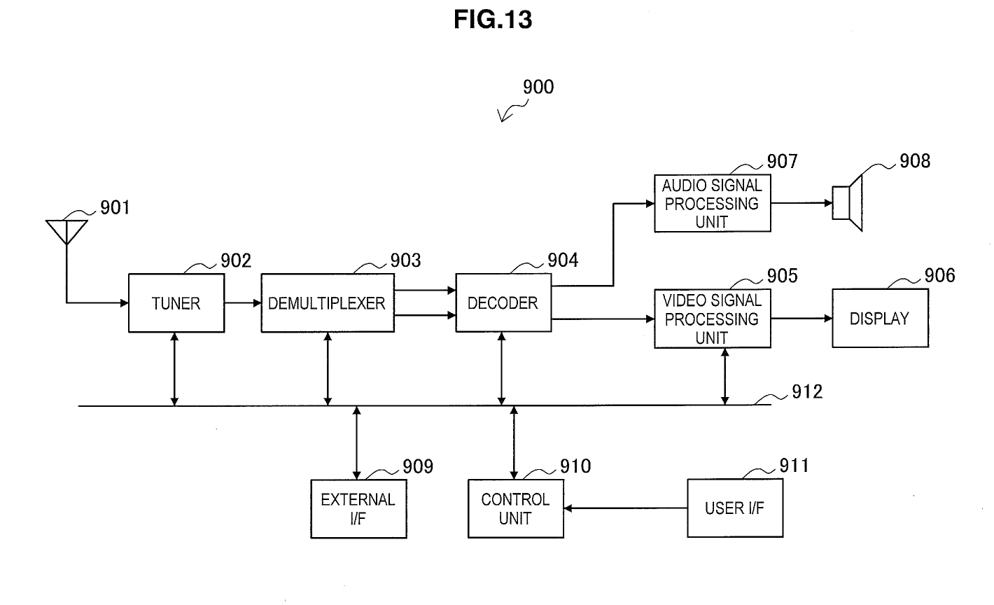

FIG. 13 is a diagram illustrating an example of a schematic configuration of a television device applying the aforementioned embodiment. A television device 900 includes an antenna 901, a tuner 902, a demultiplexer 903, a decoder 904, a video signal processing unit 905, a display 906, an audio signal processing unit 907, a speaker 908, an external interface 909, a control unit 910, a user interface 911, and a bus 912.

The tuner 902 extracts a signal of a desired channel from a broadcast signal received through the antenna 901 and demodulates the extracted signal. The tuner 902 then outputs an encoded bit stream obtained by the demodulation to the demultiplexer 903. That is, the tuner 902 has a role as transmission means receiving the encoded stream in which an image is encoded, in the television device 900.

The demultiplexer 903 isolates a video stream and an audio stream in a program to be viewed from the encoded bit stream and outputs each of the isolated streams to the decoder 904. The demultiplexer 903 also extracts auxiliary data such as an EPG (Electronic Program Guide) from the encoded bit stream and supplies the extracted data to the control unit 910. Here, the demultiplexer 903 may descramble the encoded bit stream when it is scrambled.

The decoder 904 decodes the video stream and the audio stream that are input from the demultiplexer 903. The decoder 904 then outputs video data generated by the decoding process to the video signal processing unit 905. Furthermore, the decoder 904 outputs audio data generated by the decoding process to the audio signal processing unit 907.

The video signal processing unit 905 reproduces the video data input from the decoder 904 and displays the video on the display 906. The video signal processing unit 905 may also display an application screen supplied through the network on the display 906. The video signal processing unit 905 may further perform an additional process such as noise reduction on the video data according to the setting. Furthermore, the video signal processing unit 905 may generate an image of a GUI (Graphical User Interface) such as a menu, a button, or a cursor and superpose the generated image onto the output image.

The display 906 is driven by a drive signal supplied from the video signal processing unit 905 and displays video or an image on a video screen of a display device (such as a liquid crystal display, a plasma display, or an OELD (Organic ElectroLuminescence Display)).

The audio signal processing unit 907 performs a reproducing process such as D/A conversion and amplification on the audio data input from the decoder 904 and outputs the audio from the speaker 908. The audio signal processing unit 907 may also perform an additional process such as noise reduction on the audio data.

The external interface 909 is an interface that connects the television device 900 with an external device or a network. For example, the decoder 904 may decode a video stream or an audio stream received through the external interface 909. This means that the external interface 909 also has a role as the transmission means receiving the encoded stream in which an image is encoded, in the television device 900.

The control unit 910 includes a processor such as a CPU and a memory such as a RAM and a ROM. The memory stores a program executed by the CPU, program data, EPG data, and data acquired through the network. The program stored in the memory is read by the CPU at the start-up of the television device 900 and executed, for example. By executing the program, the CPU controls the operation of the television device 900 in accordance with an operation signal that is input from the user interface 911, for example.

The user interface 911 is connected to the control unit 910. The user interface 911 includes a button and a switch for a user to operate the television device 900 as well as a reception part which receives a remote control signal, for example. The user interface 911 detects a user operation through these components, generates the operation signal, and outputs the generated operation signal to the control unit 910.

The bus 912 mutually connects the tuner 902, the demultiplexer 903, the decoder 904, the video signal processing unit 905, the audio signal processing unit 907, the external interface 909, and the control unit 910.

The decoder 904 in the television device 900 configured in the aforementioned manner has a function of the image decoding device 60 according to the aforementioned embodiment. As a result, it is possible to appropriately decode the encoded stream having the bit-depth-related information in which redundancy is avoided in the television device 900.

### (2) Second Application Example

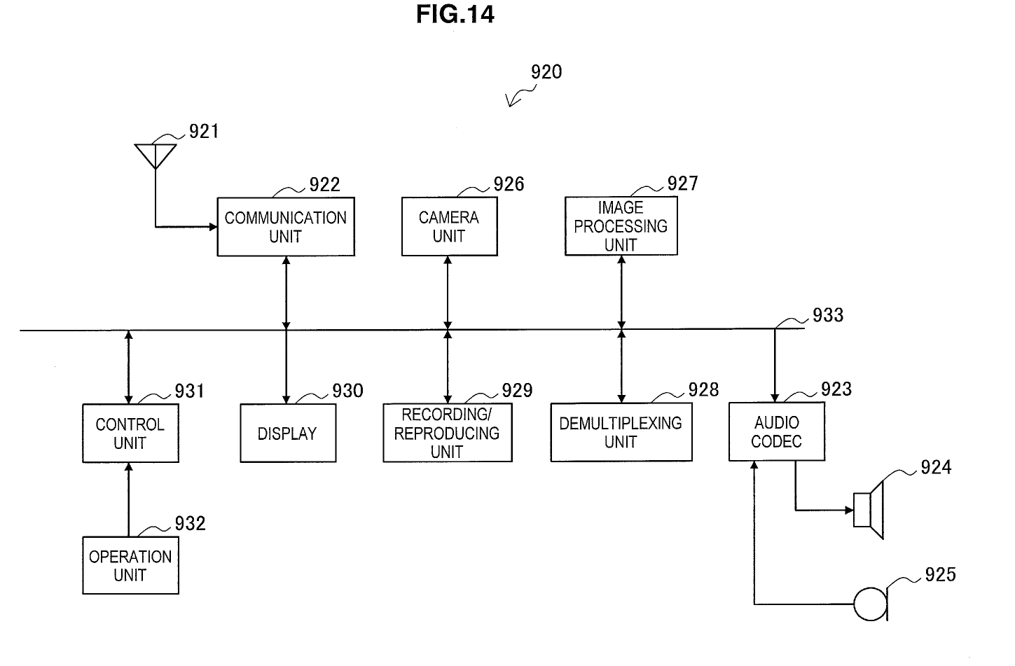

FIG. 14 is a diagram illustrating an example of a schematic configuration of a mobile telephone applying the aforementioned embodiment. A mobile telephone 920 includes an antenna 921, a communication unit 922, an audio codec 923, a speaker 924, a microphone 925, a camera unit 926, an image processing unit 927, a demultiplexing unit 928, a recording/reproducing unit 929, a display 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the demultiplexing unit 928, the recording/reproducing unit 929, the display 930, and the control unit 931.

The mobile telephone 920 performs an operation such as transmitting/receiving an audio signal, transmitting/receiving an electronic mail or image data, imaging an image, or recording data in various operation modes including an audio call mode, a data communication mode, a photography mode, and a videophone mode.

In the audio call mode, an analog audio signal generated by the microphone 925 is supplied to the audio codec 923. The audio codec 923 then converts the analog audio signal into audio data, performs A/D conversion on the converted audio data, and compresses the data. The audio codec 923 thereafter outputs the compressed audio data to the communication unit 922. The communication unit 922 encodes and modulates the audio data to generate a transmission signal. The communication unit 922 then transmits the generated transmission signal to a base station (not shown) through the antenna 921. Furthermore, the communication unit 922 amplifies a radio signal received through the antenna 921, converts a frequency of the signal, and acquires a reception signal. The communication unit 922 thereafter demodulates and decodes the reception signal to generate the audio data and output the generated audio data to the audio codec 923. The audio codec 923 expands the audio data, performs D/A conversion on the data, and generates the analog audio signal. The audio codec 923 then outputs the audio by supplying the generated audio signal to the speaker 924.

In the data communication mode, for example, the control unit 931 generates character data configuring an electronic mail, in accordance with a user operation through the operation unit 932. The control unit 931 further displays a character on the display 930. Moreover, the control unit 931 generates electronic mail data in accordance with a transmission instruction from a user through the operation unit 932 and outputs the generated electronic mail data to the communication unit 922. The communication unit 922 encodes and modulates the electronic mail data to generate a transmission signal. Then, the communication unit 922 transmits the generated transmission signal to the base station (not shown) through the antenna 921. The communication unit 922 further amplifies a radio signal received through the antenna 921, converts a frequency of the signal, and acquires a reception signal. The communication unit 922 thereafter demodulates and decodes the reception signal, restores the electronic mail data, and outputs the restored electronic mail data to the control unit 931. The control unit 931 displays the content of the electronic mail on the display 930 as well as stores the electronic mail data in a storage medium of the recording/reproducing unit 929.

The recording/reproducing unit 929 includes an arbitrary storage medium that is readable and writable. For example, the storage medium may be a built-in storage medium such as a RAM or a flash memory, or may be an externally-mounted storage medium such as a hard disk, a magnetic disk, a magneto-optical disk, an optical disk, a USB (Unallocated Space Bitmap) memory, or a memory card.

In the photography mode, for example, the camera unit 926 images an object, generates image data, and outputs the generated image data to the image processing unit 927. The image processing unit 927 encodes the image data input from the camera unit 926 and stores an encoded stream in the storage medium of the recording/reproducing unit 929.

In the videophone mode, for example, the demultiplexing unit 928 multiplexes a video stream encoded by the image processing unit 927 and an audio stream input from the audio codec 923, and outputs the multiplexed stream to the communication unit 922. The communication unit 922 encodes and modulates the stream to generate a transmission signal. The communication unit 922 subsequently transmits the generated transmission signal to the base station (not shown) through the antenna 921. Moreover, the communication unit 922 amplifies a radio signal received through the antenna 921, converts a frequency of the signal, and acquires a reception signal. The transmission signal and the reception signal can include an encoded bit stream. Then, the communication unit 922 demodulates and decodes the reception signal to restore the stream, and outputs the restored stream to the demultiplexing unit 928. The demultiplexing unit 928 isolates the video stream and the audio stream from the input stream and outputs the video stream and the audio stream to the image processing unit 927 and the audio codec 923, respectively. The image processing unit 927 decodes the video stream to generate video data. The video data is then supplied to the display 930, which displays a series of images. The audio codec 923 expands and performs D/A conversion on the audio stream to generate an analog audio signal. The audio codec 923 then supplies the generated audio signal to the speaker 924 to output the audio.

The image processing unit 927 in the mobile telephone 920 configured in the aforementioned manner has a function of the image encoding device 1 and the image decoding device 6 according to the aforementioned embodiment. As a result, it is possible to appropriately encode or decode the encoded stream having the bit-depth-related information in which redundancy is avoided in the mobile telephone 920.

### (3) Third Application Example

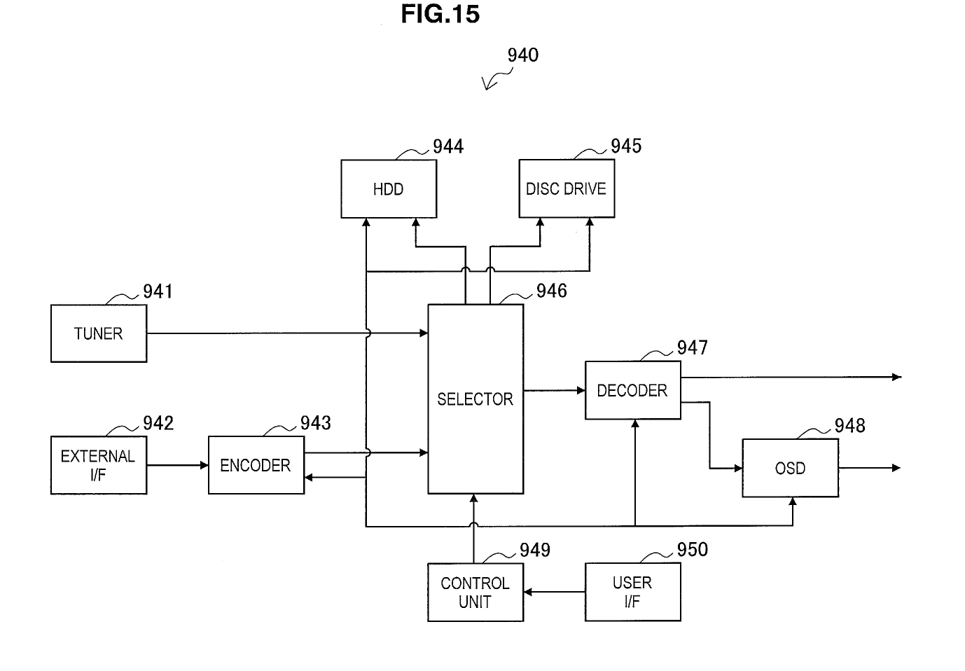

FIG. 15 is a diagram illustrating an example of a schematic configuration of a recording/reproducing device applying the aforementioned embodiment. A recording/reproducing device 940 encodes audio data and video data of a broadcast program received and records the data into a recording medium, for example. The recording/reproducing device 940 may also encode audio data and video data acquired from another device and record the data into the recording medium, for example. In response to a user instruction, for example, the recording/reproducing device 940 reproduces the data recorded in the recording medium on a monitor and a speaker. The recording/reproducing device 940 at this time decodes the audio data and the video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a control unit 949, and a user interface 950.

The tuner 941 extracts a signal of a desired channel from a broadcast signal received through an antenna (not shown) and demodulates the extracted signal. The tuner 941 then outputs an encoded bit stream obtained by the demodulation to the selector 946. That is, the tuner 941 has a role as transmission means in the recording/reproducing device 940.

The external interface 942 is an interface which connects the recording/reproducing device 940 with an external device or a network. The external interface 942 may be, for example, an IEEE 1394 interface, a network interface, a USB interface, or a flash memory interface. The video data and the audio data received through the external interface 942 are input to the encoder 943, for example. That is, the external interface 942 has a role as transmission means in the recording/reproducing device 940.

The encoder 943 encodes the video data and the audio data when the video data and the audio data input from the external interface 942 are not encoded. The encoder 943 thereafter outputs an encoded bit stream to the selector 946.

The HDD 944 records, into an internal hard disk, the encoded bit stream in which content data such as video and audio is compressed, various programs, and other data. The HDD 944 reads these data from the hard disk when reproducing the video and the audio.

The disk drive 945 records and reads data into/from a recording medium which is mounted to the disk drive. The recording medium mounted to the disk drive 945 may be, for example, a DVD disk (such as DVD-Video, DVD-RAM, DVD-R, DVD-RW, DVD+R, or DVD+RW) or a Blu-ray (Registered Trademark) disk.

The selector 946 selects the encoded bit stream input from the tuner 941 or the encoder 943 when recording the video and audio, and outputs the selected encoded bit stream to the HDD 944 or the disk drive 945. When reproducing the video and audio, on the other hand, the selector 946 outputs the encoded bit stream input from the HDD 944 or the disk drive 945 to the decoder 947.

The decoder 947 decodes the encoded bit stream to generate the video data and the audio data. The decoder 904 then outputs the generated video data to the OSD 948 and the generated audio data to an external speaker.

The OSD 948 reproduces the video data input from the decoder 947 and displays the video. The OSD 948 may also superpose an image of a GUI such as a menu, a button, or a cursor onto the video displayed.

The control unit 949 includes a processor such as a CPU and a memory such as a RAM and a ROM. The memory stores a program executed by the CPU as well as program data. The program stored in the memory is read by the CPU at the start-up of the recording/reproducing device 940 and executed, for example. By executing the program, the CPU controls the operation of the recording/reproducing device 940 in accordance with an operation signal that is input from the user interface 950, for example.

The user interface 950 is connected to the control unit 949. The user interface 950 includes a button and a switch for a user to operate the recording/reproducing device 940 as well as a reception part which receives a remote control signal, for example. The user interface 950 detects a user operation through these components, generates the operation signal, and outputs the generated operation signal to the control unit 949.

The encoder 943 in the recording/reproducing device 940 configured in the aforementioned manner has a function of the image encoding device 1 according to the aforementioned embodiment. On the other hand, the decoder 947 has a function of the image decoding device 6 according to the aforementioned embodiment. As a result, it is possible to appropriately encode or decode the encoded stream having the bit-depth-related information in which redundancy is avoided in the recording/reproducing device 940.

### (4) Fourth Application Example

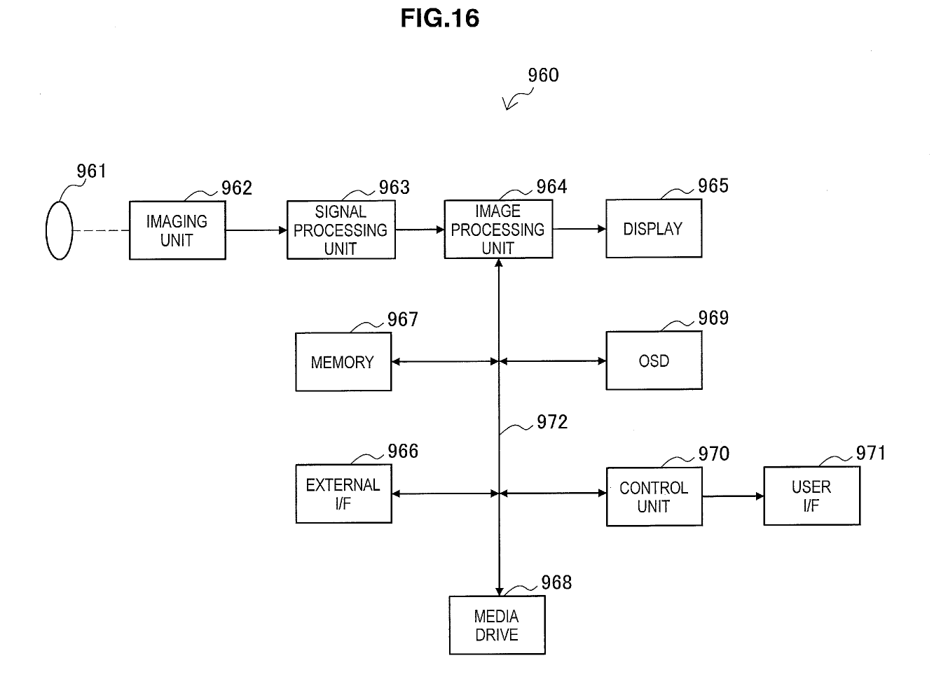

FIG. 16 shows an example of a schematic configuration of an image capturing device applying the aforementioned embodiment. An imaging device 960 images an object, generates an image, encodes image data, and records the data into a recording medium.

The imaging device 960 includes an optical block 961, an imaging unit 962, a signal processing unit 963, an image processing unit 964, a display 965, an external interface 966, a memory 967, a media drive 968, an OSD 969, a control unit 970, a user interface 971, and a bus 972.

The optical block 961 is connected to the imaging unit 962. The imaging unit 962 is connected to the signal processing unit 963. The display 965 is connected to the image processing unit 964. The user interface 971 is connected to the control unit 970. The bus 972 mutually connects the image processing unit 964, the external interface 966, the memory 967, the media drive 968, the OSD 969, and the control unit 970.

The optical block 961 includes a focus lens and a diaphragm mechanism. The optical block 961 forms an optical image of the object on an imaging surface of the imaging unit 962. The imaging unit 962 includes an image sensor such as a CCD (Charge Coupled Device) or a CMOS (Complementary Metal Oxide Semiconductor) and performs photoelectric conversion to convert the optical image formed on the imaging surface into an image signal as an electric signal. Subsequently, the imaging unit 962 outputs the image signal to the signal processing unit 963.

The signal processing unit 963 performs various camera signal processes such as a knee correction, a gamma correction and a color correction on the image signal input from the imaging unit 962. The signal processing unit 963 outputs the image data, on which the camera signal process has been performed, to the image processing unit 964.

The image processing unit 964 encodes the image data input from the signal processing unit 963 and generates the encoded data. The image processing unit 964 then outputs the generated encoded data to the external interface 966 or the media drive 968. The image processing unit 964 also decodes the encoded data input from the external interface 966 or the media drive 968 to generate image data. The image processing unit 964 then outputs the generated image data to the display 965. Moreover, the image processing unit 964 may output to the display 965 the image data input from the signal processing unit 963 to display the image. Furthermore, the image processing unit 964 may superpose display data acquired from the OSD 969 onto the image that is output on the display 965.

The OSD 969 generates an image of a GUI such as a menu, a button, or a cursor and outputs the generated image to the image processing unit 964.

The external interface 966 is configured as a USB input/output terminal, for example. The external interface 966 connects the imaging device 960 with a printer when printing an image, for example. Moreover, a drive is connected to the external interface 966 as needed. A removable medium such as a magnetic disk or an optical disk is mounted to the drive, for example, so that a program read from the removable medium can be installed to the imaging device 960. The external interface 966 may also be configured as a network interface that is connected to a network such as a LAN or the Internet. That is, the external interface 966 has a role as transmission means in the imaging device 960.

The recording medium mounted to the media drive 968 may be an arbitrary removable medium that is readable and writable such as a magnetic disk, a magneto-optical disk, an optical disk, or a semiconductor memory. Furthermore, the recording medium may be fixedly mounted to the media drive 968 so that a non-transportable storage unit such as a built-in hard disk drive or an SSD (Solid State Drive) is configured, for example.

The control unit 970 includes a processor such as a CPU and a memory such as a RAM and a ROM. The memory stores a program executed by the CPU as well as program data. The program stored in the memory is read by the CPU at the start-up of the imaging device 960 and then executed. By executing the program, the CPU controls the operation of the imaging device 960 in accordance with an operation signal that is input from the user interface 971, for example.

The user interface 971 is connected to the control unit 970. The user interface 971 includes a button and a switch for a user to operate the imaging device 960, for example. The user interface 971 detects a user operation through these components, generates the operation signal, and outputs the generated operation signal to the control unit 970.

The image processing unit 964 in the imaging device 960 configured in the aforementioned manner has a function of the image encoding device 10 and the image decoding device 60 according to the aforementioned embodiment. As a result, it is possible to appropriately encode or decode the encoded stream having the bit-depth-related information in which redundancy is avoided in the imaging device 960.

### 7. SCALABLE VIDEO CODING

[7-1. Additional Differential Encoding of Bit-Depth-Related Information]

The idea such as the reduction of the code amount of the bit-depth-related information based on the differential encoding may be applied to the scalable video coding technology. For example, the above-described idea can be applied to individual layers included in an encoded stream of multiple layers. In addition, a bit depth for a luma component of an enhancement layer image may be differentially encoded based on a bit depth for a luma component of a base layer image. In this case, the luma bit depth information (of the non-PCM) of the enhancement layer may indicate the bit depth difference between the luma bit depth of the enhancement layer image and the luma bit depth of the base layer image. As a result, it is possible to further reduce the code amount of the bit depth information of the enhancement layer. For example, the bit depth information of the enhancement layer may be encoded in a representation format in a video parameter set (VPS) rather than the SPS.

Further, a linear transform of each color component using a weight and an offset in the weighted prediction may be used for color gamut conversion in which a color gamut differs according to a layer. In this regard, in a syntax defining a weight and an offset for color gamut conversion between layers, the code amount of the weight denominator information specifying the denominator of the weight of the chroma component may be reduced by the differential encoding technique described using Formula (6). Further, even when the weighted prediction is executed for dynamic range conversion between layers, in a syntax defining a weight and an offset for dynamic range conversion, the code amount of the weight denominator information specifying the denominator of the weight of the chroma component may be similarly reduced.

[7-2. Basic Configuration Example of Encoder]

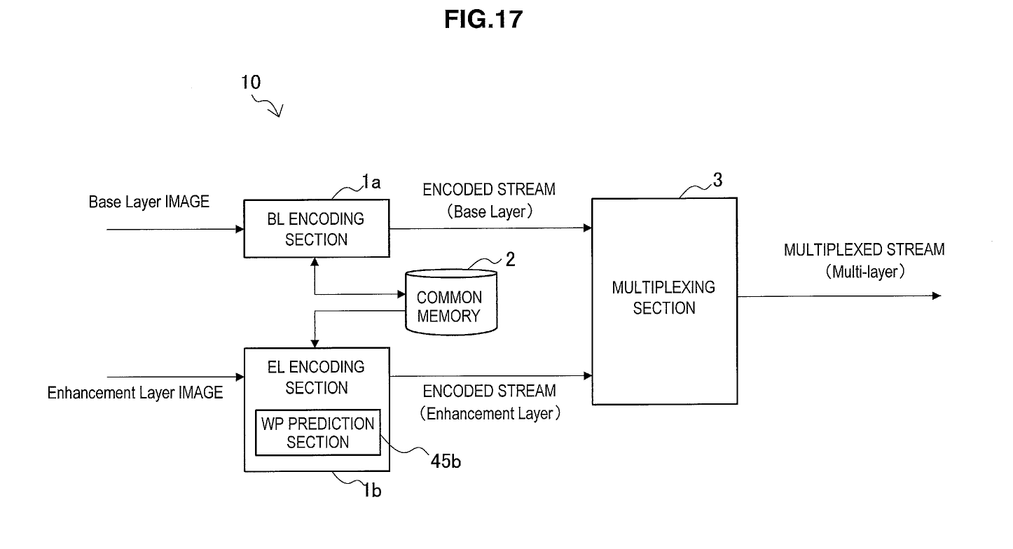

FIG. 17 is a block diagram showing a schematic configuration of an image encoding device 10 according to an embodiment supporting scalable video coding. Referring to FIG. 17, the image encoding device 10 includes a base layer (BL) encoding section 1a, an enhancement layer (EL) encoding section 1b, a common memory 2, and a multiplexing section 3.

The BL encoding section 1a encodes a base layer image to generate an encoded stream of the base layer. The EL encoding section 1b encodes an enhancement layer image to generate an encoded stream of an enhancement layer. The common memory 2 stores information commonly used between layers. The multiplexing section 3 multiplexes an encoded stream of the base layer generated by the BL encoding section 1a and an encoded stream of at least one enhancement layer generated by the EL encoding section 1b to generate a multilayer multiplexed stream.

The common memory 2 stores, for example, the luma bit depth information of the base layer. The EL encoding section 1b may differentially encode the luma bit depth information of the enhancement layer using the luma bit depth information of the base layer stored in the common memory 2. The EL encoding section 1b includes a weighted (WP) prediction section 45b. The WP prediction section 45b executes the weighted prediction for the color gamut conversion or the dynamic range conversion between layers. Further, the WP prediction section 45b may differentially encode the weight denominator information specifying the denominator of the weight of the chroma component using the bit depth difference between the luma component and the chroma component.

[7-3. Basic Configuration Example of Decoder]

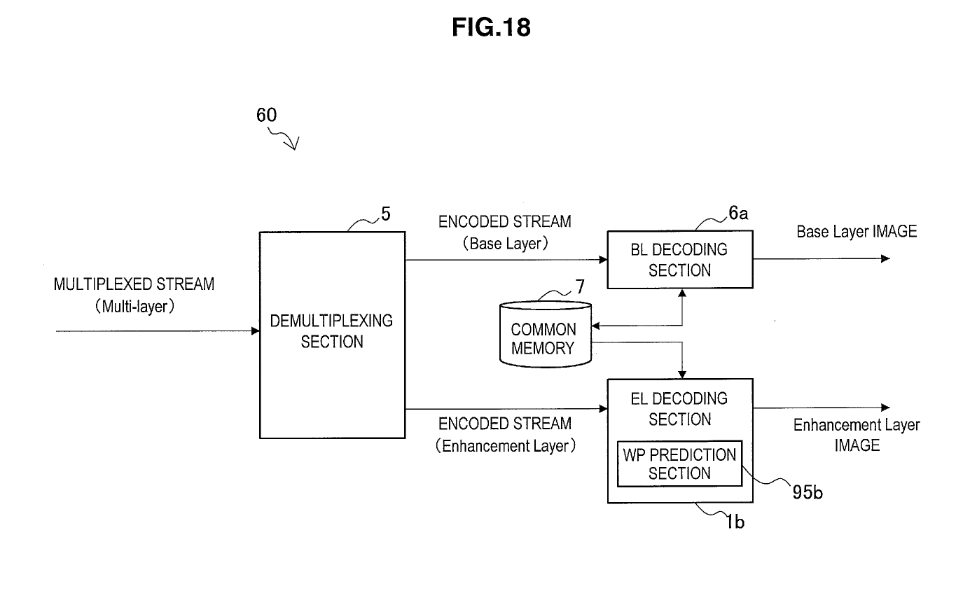

FIG. 18 is a block diagram showing a schematic configuration of an image decoding device 60 according to an embodiment supporting scalable video coding. Referring to FIG. 18, the image decoding device 60 includes a demultiplexing section 5, a base layer (BL) decoding section 6a, an enhancement layer (EL) decoding section 6b, and a common memory 7.

The demultiplexing section 5 demultiplexes a multilayer multiplexed stream into an encoded stream of the base layer and an encoded stream of at least one enhancement layer. The BL decoding section 6a decodes a base layer image from an encoded stream of the base layer. The EL decoding section 6b decodes an enhancement layer image from an encoded stream of an enhancement layer. The common memory 7 stores information commonly used between layers.

The common memory 7 stores, for example, the luma bit depth information of the base layer. The EL decoding section 6b may differentially decode the luma bit depth information of the enhancement layer using the luma bit depth information of the base layer stored in the common memory 7. The EL decoding section 6b includes a weighted (WP) prediction section 95b. The WP prediction section 95b executes the weighted prediction for the color gamut conversion or the dynamic range conversion between layers. Further, the WP prediction section 95b may differentially decode the weight denominator information specifying the denominator of the weight of the chroma component using the bit depth difference between the luma component and the chroma component.

[7-4. Various Uses of Scalable Video Coding]

Advantages of scalable video coding described above can be enjoyed in various uses. Three examples of use will be described below.

### (1) First Example

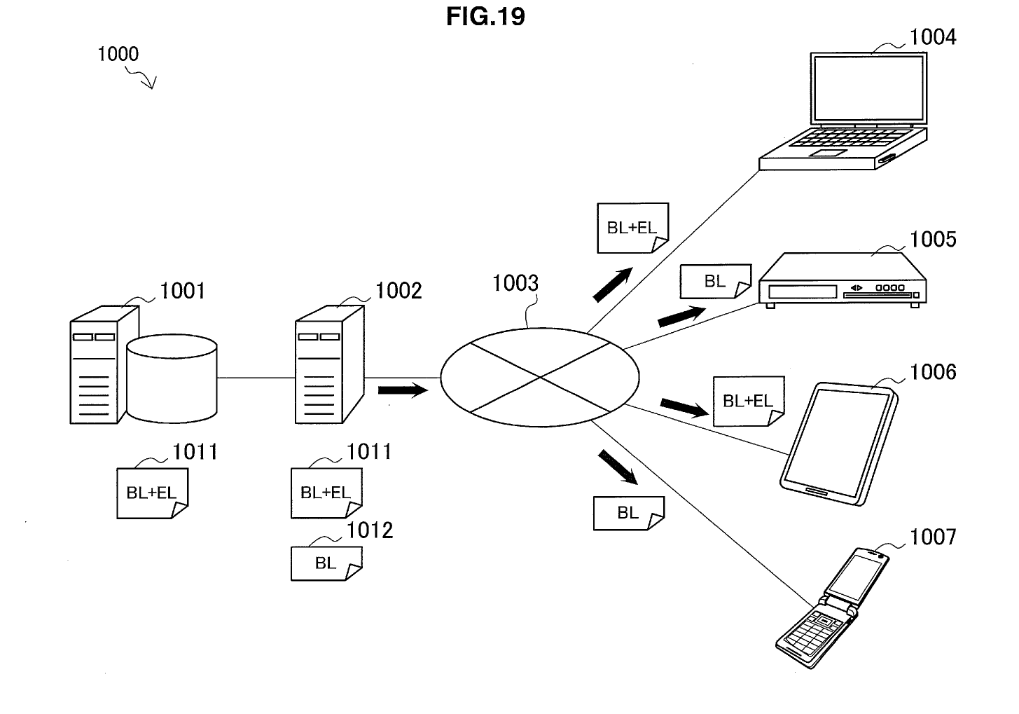

In the first example, scalable video coding is used for selective transmission of data. Referring to FIG. 19, a data transmission system 1000 includes a stream storage device 1001 and a delivery server 1002. The delivery server 1002 is connected to some terminal devices via a network 1003. The network 1003 may be a wire network or a wireless network or a combination thereof. FIG. 19 shows a PC (Personal Computer) 1004, an AV device 1005, a tablet device 1006, and a mobile phone 1007 as examples of the terminal devices.

The stream storage device 1001 stores, for example, stream data 1011 including a multiplexed stream generated by the image encoding device 10. The multiplexed stream includes an encoded stream of the base layer (BL) and an encoded stream of an enhancement layer (EL). The delivery server 1002 reads the stream data 1011 stored in the stream storage device 1001 and delivers at least a portion of the read stream data 1011 to the PC 1004, the AV device 1005, the tablet device 1006, and the mobile phone 1007 via the network 1003.

When a stream is delivered to a terminal device, the delivery server 1002 selects the stream to be delivered based on some condition such as capabilities of a terminal device or the communication environment. For example, the delivery server 1002 may avoid a delay in a terminal device or an occurrence of overflow or overload of a processor by not delivering an encoded stream having high image quality exceeding image quality that can be handled by the terminal device. The delivery server 1002 may also avoid occupation of communication bands of the network 1003 by not delivering an encoded stream having high image quality. On the other hand, when there is no risk to be avoided or it is considered to be appropriate based on a user's contract or some condition, the delivery server 1002 may deliver an entire multiplexed stream to a terminal device.

In the example of FIG. 19, the delivery server 1002 reads the stream data 1011 from the stream storage device 1001. Then, the delivery server 1002 delivers the stream data 1011 directly to the PC 1004 having high processing capabilities. Because the AV device 1005 has low processing capabilities, the delivery server 1002 generates stream data 1012 containing only an encoded stream of the base layer extracted from the stream data 1011 and delivers the stream data 1012 to the AV device 1005. The delivery server 1002 delivers the stream data 1011 directly to the tablet device 1006 capable of communication at a high communication rate. Because the mobile phone 1007 can communicate at a low communication rate, the delivery server 1002 delivers the stream data 1012 containing only an encoded stream of the base layer to the mobile phone 1007.

By using the multiplexed stream in this manner, the amount of traffic to be transmitted can adaptively be adjusted. The code amount of the stream data 1011 is reduced when compared with a case when each layer is individually encoded and thus, even if the whole stream data 1011 is delivered, the load on the network 1003 can be lessened. Further, memory resources of the stream storage device 1001 are saved.

Hardware performance of the terminal devices is different from device to device. In addition, capabilities of applications run on the terminal devices are diverse. Further, communication capacities of the network 1003 are varied. Capacities available for data transmission may change every moment due to other traffic. Thus, before starting delivery of stream data, the delivery server 1002 may acquire terminal information about hardware performance and application capabilities of terminal devices and network information about communication capacities of the network 1003 through signaling with the delivery destination terminal device. Then, the delivery server 1002 can select the stream to be delivered based on the acquired information.

Incidentally, the layer to be decoded may be extracted by the terminal device. For example, the PC 1004 may display a base layer image extracted and decoded from a received multiplexed stream on the screen thereof. After generating the stream data 1012 by extracting an encoded stream of the base layer from a received multiplexed stream, the PC 1004 may cause a storage medium to store the stream data 1012 or transfer the stream data to another device.

The configuration of the data transmission system 1000 shown in FIG. 19 is only an example. The data transmission system 1000 may include any numbers of the stream storage device 1001, the delivery server 1002, the network 1003, and terminal devices.

### (2) Second Example

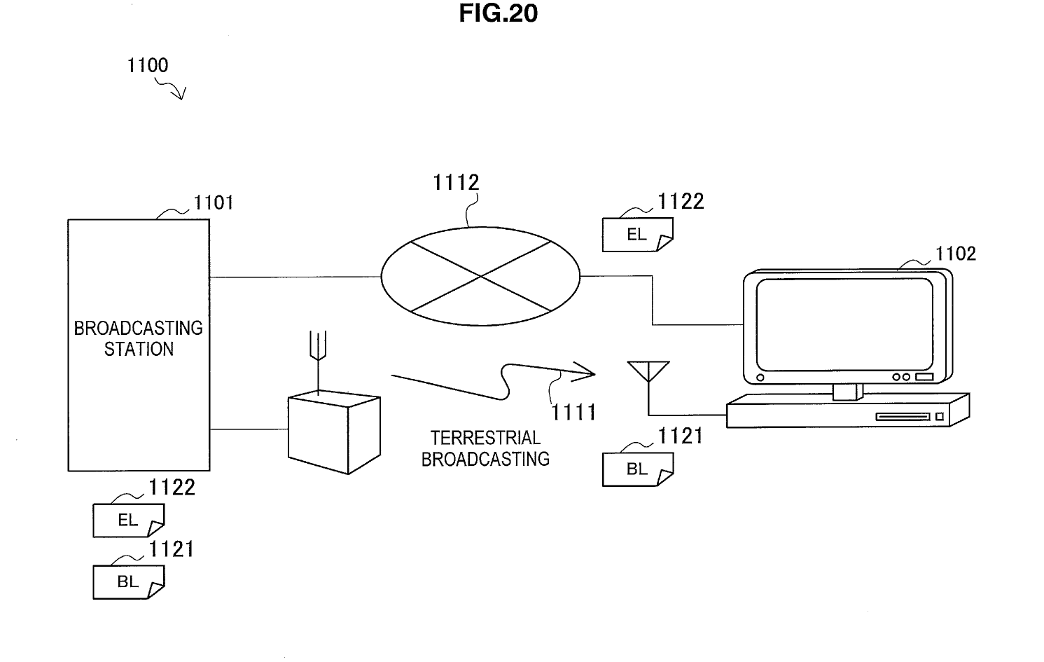

In the second example, scalable video coding is used for transmission of data via a plurality of communication channels. Referring to FIG. 20, a data transmission system 1100 includes a broadcasting station 1101 and a terminal device 1102. The broadcasting station 1101 broadcasts an encoded stream 1121 of the base layer on a terrestrial channel 1111. The broadcasting station 1101 also broadcasts an encoded stream 1122 of an enhancement layer to the terminal device 1102 via a network 1112.

The terminal device 1102 has a receiving function to receive terrestrial broadcasting broadcast by the broadcasting station 1101 and receives the encoded stream 1121 of the base layer via the terrestrial channel 1111. The terminal device 1102 also has a communication function to communicate with the broadcasting station 1101 and receives the encoded stream 1122 of an enhancement layer via the network 1112.

After receiving the encoded stream 1121 of the base layer, for example, in response to user's instructions, the terminal device 1102 may decode a base layer image from the received encoded stream 1121 and display the base layer image on the screen. Alternatively, the terminal device 1102 may cause a storage medium to store the decoded base layer image or transfer the base layer image to another device.

After receiving the encoded stream 1122 of an enhancement layer via the network 1112, for example, in response to user's instructions, the terminal device 1102 may generate a multiplexed stream by multiplexing the encoded stream 1121 of the base layer and the encoded stream 1122 of an enhancement layer. The terminal device 1102 may also decode an enhancement image from the encoded stream 1122 of an enhancement layer to display the enhancement image on the screen. Alternatively, the terminal device 1102 may cause a storage medium to store the decoded enhancement layer image or transfer the enhancement layer image to another device.

As described above, an encoded stream of each layer contained in a multiplexed stream can be transmitted via a different communication channel for each layer. Accordingly, a communication delay or an occurrence of overflow can be reduced by distributing loads on individual channels.

The communication channel to be used for transmission may dynamically be selected in accordance with some condition. For example, the encoded stream 1121 of the base layer whose data amount is relatively large may be transmitted via a communication channel having a wider bandwidth and the encoded stream 1122 of an enhancement layer whose data amount is relatively small may be transmitted via a communication channel having a narrower bandwidth. The communication channel on which the encoded stream 1122 of a specific layer is transmitted may be switched in accordance with the bandwidth of the communication channel. Accordingly, the load on individual channels can be lessened more effectively.

The configuration of the data transmission system 1100 shown in FIG. 20 is only an example. The data transmission system 1100 may include any numbers of communication channels and terminal devices. The configuration of the system described here may also be applied to other uses than broadcasting.

### (3) Third Example

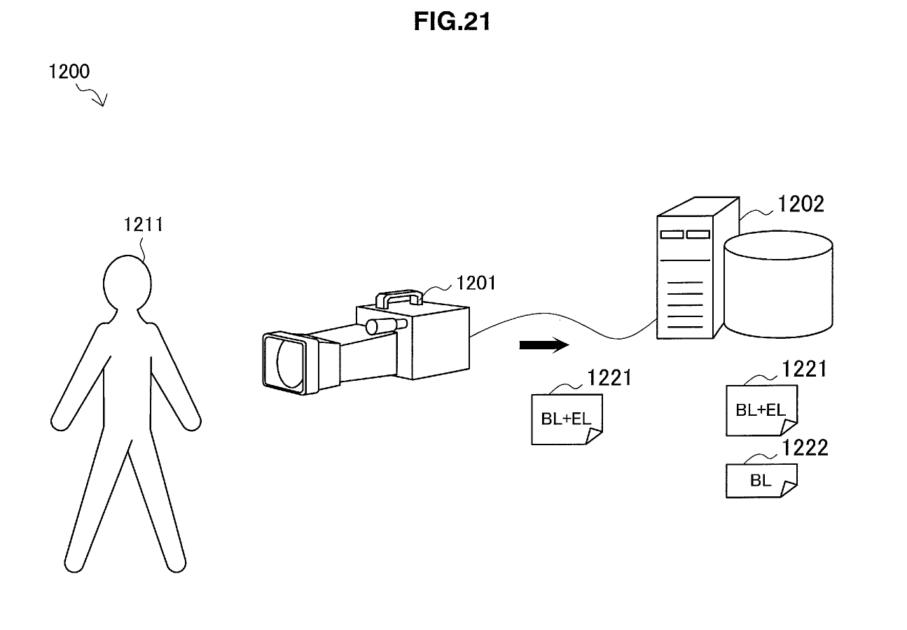

In the third example, scalable video coding is used for storage of video. Referring to FIG. 21, a data transmission system 1200 includes an imaging device 1201 and a stream storage device 1202. The imaging device 1201 scalable-encodes image data generated by a subject 1211 being imaged to generate a multiplexed stream 1221. The multiplexed stream 1221 includes an encoded stream of the base layer and an encoded stream of an enhancement layer. Then, the imaging device 1201 supplies the multiplexed stream 1221 to the stream storage device 1202.

The stream storage device 1202 stores the multiplexed stream 1221 supplied from the imaging device 1201 in different image quality for each mode. For example, the stream storage device 1202 extracts the encoded stream 1222 of the base layer from the multiplexed stream 1221 in normal mode and stores the extracted encoded stream 1222 of the base layer. In high quality mode, by contrast, the stream storage device 1202 stores the multiplexed stream 1221 as it is. Accordingly, the stream storage device 1202 can store a high-quality stream with a large amount of data only when recording of video in high quality is desired. Therefore, memory resources can be saved while the influence of image degradation on users is curbed.

For example, the imaging device 1201 is assumed to be a surveillance camera. When no surveillance object (for example, no intruder) appears in a captured image, the normal mode is selected. In this case, the captured image is likely to be unimportant and priority is given to the reduction of the amount of data so that the video is recorded in low image quality (that is, only the encoded stream 1222 of the base layer is stored). In contract, when a surveillance object (for example, the subject 1211 as an intruder) appears in a captured image, the high-quality mode is selected. In this case, the captured image is likely to be important and priority is given to high image quality so that the video is recorded in high image quality (that is, the multiplexed stream 1221 is stored).

In the example of FIG. 21, the mode is selected by the stream storage device 1202 based on, for example, an image analysis result. However, the present embodiment is not limited to such an example and the imaging device 1201 may select the mode. In the latter case, imaging device 1201 may supply the encoded stream 1222 of the base layer to the stream storage device 1202 in normal mode and the multiplexed stream 1221 to the stream storage device 1202 in high-quality mode.

Selection criteria for selecting the mode may be any criteria. For example, the mode may be switched in accordance with the loudness of voice acquired through a microphone or the waveform of voice. The mode may also be switched periodically. Also, the mode may be switched in response to user's instructions. Further, the number of selectable modes may be any number as long as the number of hierarchized layers is not exceeded.

The configuration of the data transmission system 1200 shown in FIG. 21 is only an example. The data transmission system 1200 may include any number of the imaging device 1201. The configuration of the system described here may also be applied to other uses than the surveillance camera.

[7-5. Others]

(1) Application to the Multi-View Codec

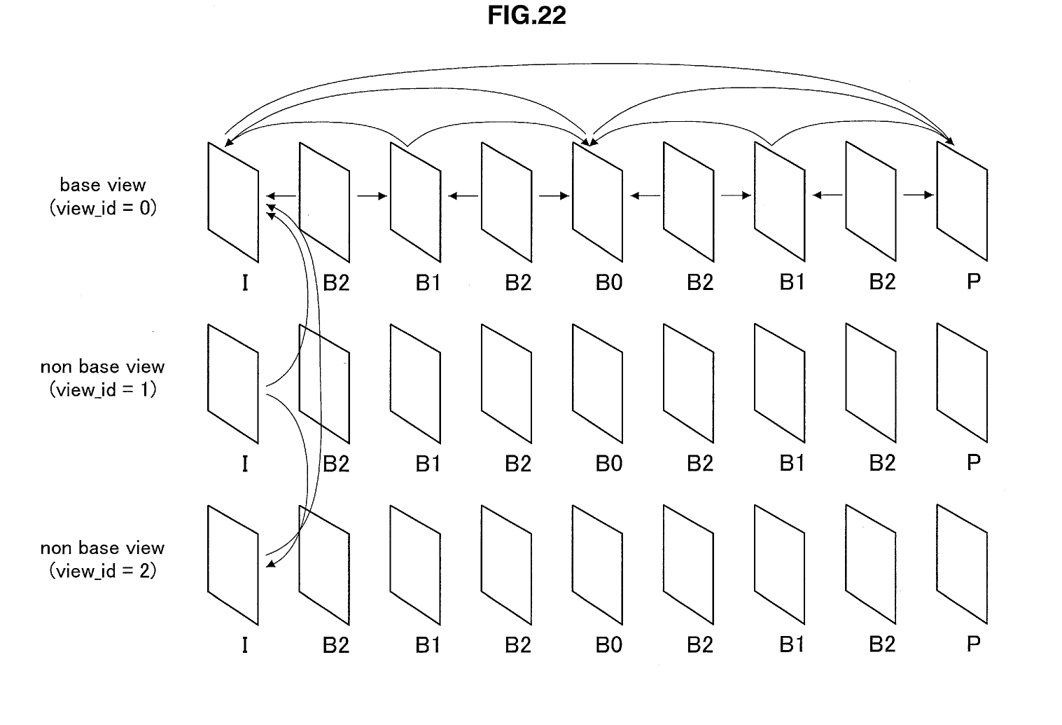

The multi-view codec is a kind of multi-layer codec and is an image encoding system to encode and decode so-called multi-view video. FIG. 22 is an explanatory view illustrating a multi-view codec. Referring to FIG. 22, sequences of three view frames captured from three viewpoints are shown. A view ID (view_id) is attached to each view. Among a plurality of these views, one view is specified as the base view. Views other than the base view are called non-base views. In the example of FIG. 22, the view whose view ID is “0” is the base view and two views whose view ID is “1” or “2” are non-base views. When these views are hierarchically encoded, each view may correspond to a layer. As indicated by arrows in FIG. 22, an image of a non-base view is encoded and decoded by referring to an image of the base view (an image of the other non-base view may also be referred to).

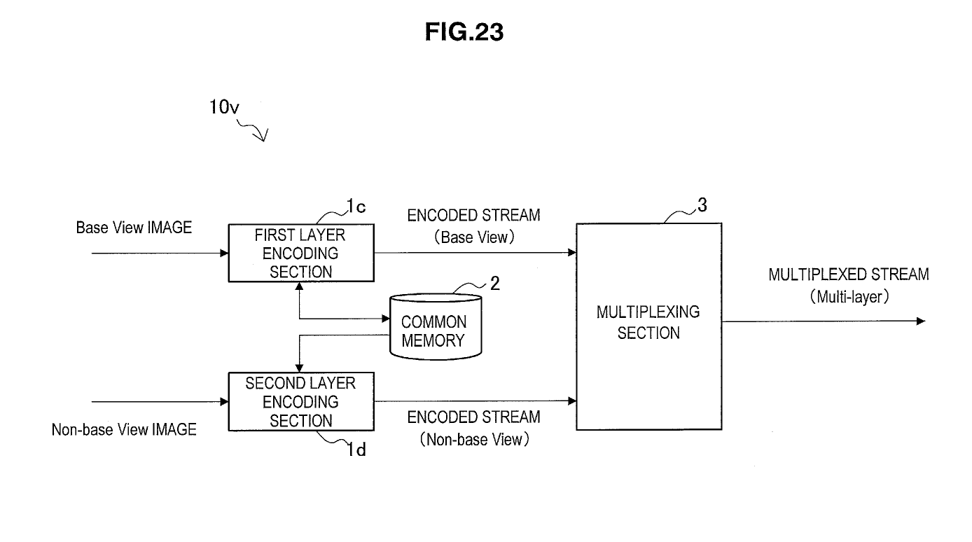

FIG. 23 is a block diagram showing a schematic configuration of an image encoding device 10v supporting the multi-view codec. Referring to FIG. 23, the image encoding device 10v includes a first layer encoding section 1c, a second layer encoding section id, the common memory 2, and the multiplexing section 3.

The function of the first layer encoding section 1c is the same as that of the BL encoding section 1a described using FIG. 17 except that, instead of a base layer image, a base view image is received as input. The first layer encoding section 1c encodes the base view image to generate an encoded stream of a first layer. The function of the second layer encoding section 1d is the same as that of the EL encoding section 1b described using FIG. 17 except that, instead of an enhancement layer image, a non-base view image is received as input. The second layer encoding section 1d encodes the non-base view image to generate an encoded stream of a second layer. The common memory 2 stores information commonly used between layers. The multiplexing section 3 multiplexes an encoded stream of the first layer generated by the first layer encoding section 1c and an encoded stream of the second layer generated by the second layer encoding section 1d to generate a multilayer multiplexed stream.

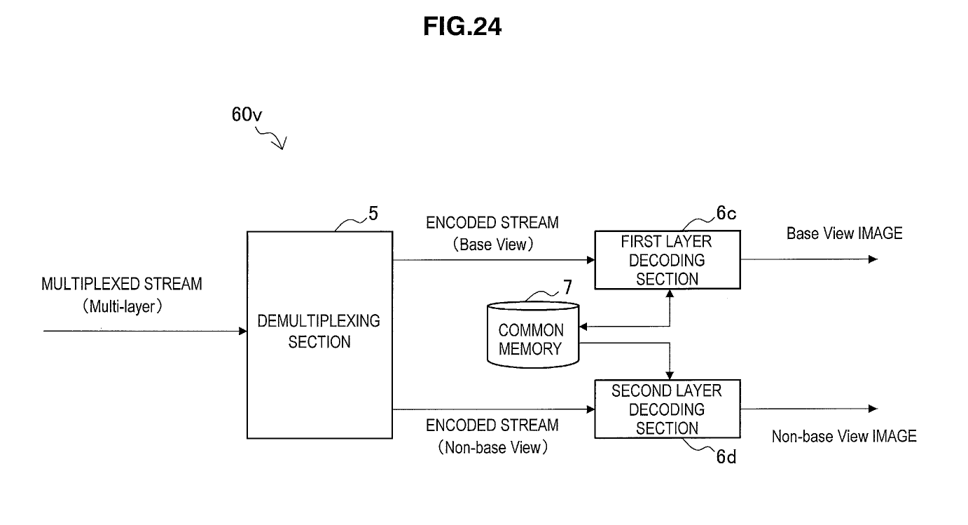

FIG. 24 is a block diagram showing a schematic configuration of an image decoding device 60v supporting the multi-view codec. Referring to FIG. 24, the image decoding device 60v includes the demultiplexing section 5, a first layer decoding section 6c, a second layer decoding section 6d, and the common memory 7.

The demultiplexing section 5 demultiplexes a multilayer multiplexed stream into an encoded stream of the first layer and an encoded stream of the second layer. The function of the first layer decoding section 6c is the same as that of the BL decoding section 6a described using FIG. 4 except that an encoded stream in which, instead of a base layer image, a base view image is encoded is received as input. The first layer decoding section 6c decodes a base view image from an encoded stream of the first layer. The function of the second layer decoding section 6d is the same as that of the EL decoding section 6b described using FIG. 4 except that an encoded stream in which, instead of an enhancement layer image, a non-base view image is encoded is received as input. The second layer decoding section 6d decodes a non-base view image from an encoded stream of the second layer. The common memory 7 stores information commonly used between layers.

(2) Application to Streaming Technology

Technology in the present disclosure may also be applied to a streaming protocol. In MPEG-DASH (Dynamic Adaptive Streaming over HTTP), for example, a plurality of encoded streams having mutually different parameters such as the resolution is prepared by a stream server in advance. Then, the streaming server dynamically selects appropriate data for streaming from the plurality of encoded streams and delivers the selected data. In this streaming protocol, the bit-depth-related information may be differentially encoded between the encoded streams according to the technology according to the present disclosure.

### 8. CONCLUSION

Embodiments of the technology according to the present disclosure have been described above in detail with reference to FIGS. 1 to 24. According to the above embodiments, the chroma bit depth for the chroma component of the encoded or decoded image is calculated based on the luma bit depth indicated by the luma bit depth information and the bit depth difference indicated by the chroma bit depth information. Thus, in many uses in which the difference between the luma bit depth and the chroma bit depth is zero or a value close to zero, it is possible to reduce the code amount of the chroma bit depth information. Further, it is also possible to further reduce the code amount of the bit-depth-related information by further differentially encoding the parameter that can have a correlation with the bit depth such as the denominator of the weight of the weighted prediction using the bit depth difference indicated by the chroma bit depth information.

According to the above embodiments, the PCM bit depth for the PCM sample of the encoded or decoded image is calculated based on the non-PCM bit depth indicated by the non-PCM bit depth information and the bit depth difference indicated by the PCM bit depth information. Thus, in many uses in which the difference between the non-PCM sample and the PCM sample is not large, it is possible to reduce the code amount of the non-PCM bit depth information. It is also possible to reduce the code amount of the PCM chroma bit depth information using the bit depth difference between the luma component and the chroma component of the non-PCM.

The terms “CU,” “PU,” and “TU” described in the present specification refer to logical units including a syntax associated with an individual block in HEVC. When only individual blocks which are parts of an image are focused on, the blocks may be referred to with the terms “coding block (CB),” “prediction block (PB),” and “transform block (TB).” A CB is formed by hierarchically dividing a coding tree block (CTB) in a quad-tree shape. The one entire quad-tree corresponds to the CTB and a logical unit corresponding to the CTB is referred to as a coding tree unit (CTU). The CTB and the CB in HEVC have a similar role to a macro block in H.264/AVC in that the CTB and the CB are processing units of an encoding process. However, the CTB and the CB are different from the macro block in that the sizes of the CTB and the CB are not fixed (the size of the macro block is normally 16×16 pixels). The size of the CTB is selected from a size of 16×16 pixels, a size of 32×32 pixels, and a size of 64×64 pixels and is designated by a parameter in an encoded stream. The size of the CB can be changed according to a division depth of the CTB.

Mainly described herein is the example where the various pieces of information such as the bit-depth-related information are multiplexed to the header of the encoded stream and transmitted from the encoding side to the decoding side. The method of transmitting these pieces of information however is not limited to such example. For example, these pieces of information may be transmitted or recorded as separate data associated with the encoded bit stream without being multiplexed to the encoded bit stream. Here, the term “association” means to allow the image included in the bit stream (may be a part of the image such as a slice or a block) and the information corresponding to the current image to establish a link when decoding. Namely, the information may be transmitted on a different transmission path from the image (or the bit stream). The information may also be recorded in a different recording medium (or a different recording area in the same recording medium) from the image (or the bit stream). Furthermore, the information and the image (or the bit stream) may be associated with each other by an arbitrary unit such as a plurality of frames, one frame, or a portion within a frame.

The preferred embodiments of the present disclosure have been described above with reference to the accompanying drawings, whilst the present disclosure is not limited to the above examples, of course. A person skilled in the art may find various alternations and modifications within the scope of the appended claims, and it should be understood that they will naturally come under the technical scope of the present disclosure.

The effects described in this specification are merely explanatory or exemplary and not limiting. In other words, the technology according to the present disclosure can have any other effect that is obvious to those having skill in the art from the description of this specification in addition to the above-described effects or instead of the above-described effects.

Additionally, the present technology may also be configured as below.

(1)

An image processing device including:

an acquisition section configured to acquire first bit depth information for decoding a luma component of an encoded image and second bit depth information for decoding a chroma component of the encoded image; and

a decoding section configured to decode the luma component according to the first bit depth information and decode the chroma component according to the second bit depth information,

wherein the decoding section decodes the chroma component according to a second bit depth that is calculated based on a first bit depth indicated by the first bit depth information and a bit depth difference indicated by the second bit depth information.

(2)

The image processing device according to (1), further including:

a prediction section configured to execute weighted prediction using different weights for the luma component and the chroma component,

wherein the prediction section calculates a denominator of the weight of the chroma component by including the bit depth difference.

(3)

The image processing device according to (2),

wherein the acquisition section further acquires first weight denominator information indicating a denominator of the weight of the luma component and second weight denominator information indicating a remainder difference related to the denominator of the weight of the chroma component, and

wherein the prediction section calculates the denominator of the weight of the chroma component based on the denominator of the weight of the luma component indicated by the first weight denominator information, the bit depth difference, and the remainder difference indicated by the second weight denominator information.

(4)

The image processing device according to (2) or (3),

wherein the image is an enhancement layer image that undergoes scalable video decoding, and

wherein the prediction section executes the weighted prediction for color gamut conversion or dynamic range conversion between layers.

(5)

The image processing device according to any one of (1) to (4),

wherein the image is an enhancement layer image that undergoes scalable video decoding, and

wherein the first bit depth information indicates a difference between the first bit depth for a luma component of the enhancement layer image and a bit depth for a luma component of a base layer image.

(6)

An image processing device including:

an acquisition section configured to acquire non-PCM bit depth information for decoding a non-PCM sample of an encoded image and PCM bit depth information for decoding a PCM sample of the encoded image; and

a decoding section configured to decode the non-PCM sample according to the non-PCM bit depth information and decode the PCM sample according to the PCM bit depth information,

wherein the decoding section decodes the PCM sample according to a PCM bit depth that is calculated based on a non-PCM bit depth indicated by the non-PCM bit depth information and a first bit depth difference indicated by the PCM bit depth information.

(7)

The image processing device according to (6),

wherein the non-PCM bit depth information includes first bit depth information indicating a first bit depth for a luma component of the non-PCM sample and second bit depth information indicating a second bit depth difference between the first bit depth and a second bit depth for a chroma component of the non-PCM sample, and

wherein a fourth bit depth for a chroma component of the PCM sample is calculated by including a third bit depth for a luma component of the PCM sample based on the first bit depth difference and the second bit depth difference.

(8)

The image processing device according to (7),

wherein the PCM bit depth information includes third bit depth information indicating the first bit depth difference and fourth bit depth information indicating a remainder difference related to the fourth bit depth, and

wherein the fourth bit depth is calculated based on the third bit depth, the second bit depth difference, and the remainder difference indicated by the fourth bit depth information.

(9)

The image processing device according to any one of (6) to (8),

wherein the PCM bit depth information indicates a bit depth difference that differs according to a coding unit (CU) size.

(10)

The image processing device according to (9),

wherein the PCM bit depth information indicates a bit depth difference for a second CU size that is differentially encoded based on a bit depth difference for a first CU size.

(11)

An image processing device including:

an encoding section configured to encode a luma component of an image according to a first bit depth and encode a chroma component of the image according to a second bit depth; and

a generation section configured to generate first bit depth information indicating the first bit depth and second bit depth information indicating a bit depth difference between the first bit depth and the second bit depth,

wherein the encoding section further encodes the first bit depth information and the second bit depth information.

(12)

The image processing device according to (11), further including:

a prediction section configured to execute weighted prediction using different weights for the luma component and the chroma component,

wherein a denominator of the weight of the chroma component is differentially encoded using the bit depth difference.

(13)

The image processing device according to (12),

wherein the denominator of the weight of the chroma component is calculated based on a denominator of the weight of the luma component, the bit depth difference, and a remainder difference, and

wherein the encoding section further encodes first weight denominator information indicating the denominator of the weight of the luma component and second weight denominator information indicating the remainder difference.

(14)

The image processing device according to (12) or (13),

wherein the image is an enhancement layer image that undergoes scalable video encoding, and

wherein the prediction section executes the weighted prediction for color gamut conversion or dynamic range conversion between layers.

(15)

The image processing device according to any one of (11) to (14),

wherein the image is an enhancement layer image that undergoes scalable video encoding, and

wherein the first bit depth information indicates a difference between the first bit depth for a luma component of the enhancement layer image and a bit depth for a luma component of a base layer image.

(16)

An image processing device including:

an encoding section configured to encode a non-PCM sample of an image and a PCM sample of the image according to bit depths that are defined separately; and

a generation section configured to generate non-PCM bit depth information indicating a non-PCM bit depth and PCM bit depth information indicating a first bit depth difference between the non-PCM bit depth and a PCM bit depth,

wherein the encoding section further encodes the non-PCM bit depth information and the PCM bit depth information.

(17)

The image processing device according to (16),

wherein the non-PCM bit depth information includes first bit depth information indicating a first bit depth for a luma component of the non-PCM sample and second bit depth information indicating a second bit depth difference between the first bit depth and a second bit depth for a chroma component of the non-PCM sample, and

wherein a fourth bit depth for a chroma component of the PCM sample is differentially encoded using a third bit depth for a luma component of the PCM sample and the second bit depth difference.

(18)

The image processing device according to (17),

wherein the fourth bit depth is calculated based on the third bit depth, the second bit depth difference, and a remainder difference, and

wherein the PCM bit depth information includes third bit depth information indicating the first bit depth difference and fourth bit depth information indicating the remainder difference.

(19)

The image processing device according to any one of (16) to (18),

wherein the PCM bit depth information indicates a bit depth difference that differs according to a coding unit (CU) size.

(20)

The image processing device according to (19),

wherein the PCM bit depth information indicates a bit depth difference for a second CU size that is differentially encoded based on a bit depth difference for a first CU size.

(21)

An image processing method including:

acquiring first bit depth information for decoding a luma component of an encoded image and second bit depth information for decoding a chroma component of the encoded image;

decoding the luma component according to the first bit depth information; and

decoding the chroma component according to the second bit depth information,

wherein the chroma component is decoded according to a second bit depth that is calculated based on a first bit depth indicated by the first bit depth information and a bit depth difference indicated by the second bit depth information.

(22)

An image processing method including:

acquiring non-PCM bit depth information for decoding a non-PCM sample of an encoded image and PCM bit depth information for decoding a PCM sample of the encoded image;

decoding the non-PCM sample according to the non-PCM bit depth information; and

decoding the PCM sample according to the PCM bit depth information,

wherein the PCM sample is decoded according to a PCM bit depth that is calculated based on a non-PCM bit depth indicated by the non-PCM bit depth information and a first bit depth difference indicated by the PCM bit depth information.

(23)

An image processing method including:

encoding a luma component of an image according to a first bit depth;

encoding a chroma component of the image according to a second bit depth;

generating first bit depth information indicating the first bit depth and second bit depth information indicating a bit depth difference between the first bit depth and the second bit depth; and

encoding the first bit depth information and the second bit depth information.

(24)

An image processing method including:

encoding a non-PCM sample of an image according to a non-PCM bit depth;

encoding a PCM sample of the image according to a PCM bit depth that is defined separately from the non-PCM bit depth;

generating non-PCM bit depth information indicating a non-PCM bit depth and PCM bit depth information indicating a first bit depth difference between the non-PCM bit depth and a PCM bit depth; and

encoding the non-PCM bit depth information and the PCM bit depth information.

### REFERENCE SIGNS LIST

10, 10v image encoding device (image processing device)
12 bit depth control section
16 encoding section
42, 44 information generation section
45 weighted prediction section
60, 60v image decoding device (image processing device)
62 decoding section
91, 92 information acquisition section
95 weighted prediction section

1. An image processing device comprising:
an acquisition section configured to acquire first bit depth information for decoding a luma component of an encoded image and second bit depth information for decoding a chroma component of the encoded image;
a decoding section configured to decode the luma component according to the first bit depth information and decode the chroma component according to the second bit depth information; and
a prediction section configured to execute weighted prediction using different weights for the luma component and the chroma component,
wherein the decoding section decodes the chroma component according to a second bit depth that is calculated based on a first bit depth indicated by the first bit depth information and a bit depth difference indicated by the second bit depth information, and
wherein the prediction section calculates a denominator of the weight of the chroma component by including the bit depth difference.

2. (canceled)

3. The image processing device according to claim 1,
wherein the acquisition section further acquires first weight denominator information indicating a denominator of the weight of the luma component and second weight denominator information indicating a remainder difference related to the denominator of the weight of the chroma component, and
wherein the prediction section calculates the denominator of the weight of the chroma component based on the denominator of the weight of the luma component indicated by the first weight denominator information, the bit depth difference, and the remainder difference indicated by the second weight denominator information.

4. The image processing device according to claim 1,
wherein the image is an enhancement layer image that undergoes scalable video decoding, and
wherein the prediction section executes the weighted prediction for color gamut conversion or dynamic range conversion between layers.

5. The image processing device according to claim 1,
wherein the image is an enhancement layer image that undergoes scalable video decoding, and
wherein the first bit depth information indicates a difference between the first bit depth for a luma component of the enhancement layer image and a bit depth for a luma component of a base layer image.

6. An image processing device comprising:
an acquisition section configured to acquire non-PCM bit depth information for decoding a non-PCM sample of an encoded image and PCM bit depth information for decoding a PCM sample of the encoded image; and
a decoding section configured to decode the non-PCM sample according to the non-PCM bit depth information and decode the PCM sample according to the PCM bit depth information,
wherein the decoding section decodes the PCM sample according to a PCM bit depth that is calculated based on a non-PCM bit depth indicated by the non-PCM bit depth information and a first bit depth difference indicated by the PCM bit depth information,
wherein the non-PCM bit depth information includes first bit depth information indicating a first bit depth for a luma component of the non-PCM sample and second bit depth information indicating a second bit depth difference between the first bit depth and a second bit depth for a chroma component of the non-PCM sample, and
wherein a fourth bit depth for a chroma component of the PCM sample is calculated by including a third bit depth for a luma component of the PCM sample based on the first bit depth difference and the second bit depth difference.

7. (canceled)

8. The image processing device according to claim 6,
wherein the PCM bit depth information includes third bit depth information indicating the first bit depth difference and fourth bit depth information indicating a remainder difference related to the fourth bit depth, and
wherein the fourth bit depth is calculated based on the third bit depth, the second bit depth difference, and the remainder difference indicated by the fourth bit depth information.

9. The image processing device according to claim 6,
wherein the PCM bit depth information indicates a bit depth difference that differs according to a coding unit (CU) size.

10. The image processing device according to claim 9,
wherein the PCM bit depth information indicates a bit depth difference for a second CU size that is differentially encoded based on a bit depth difference for a first CU size.

11. An image processing device comprising:
an encoding section configured to encode a luma component of an image according to a first bit depth and encode a chroma component of the image according to a second bit depth;
a generation section configured to generate first bit depth information indicating the first bit depth and second bit depth information indicating a bit depth difference between the first bit depth and the second bit depth; and
a prediction section configured to execute weighted prediction using different weights for the luma component and the chroma component,
wherein the encoding section further encodes the first bit depth information and the second bit depth information, and
wherein a denominator of the weight of the chroma component is differentially encoded using the bit depth difference.

12. (canceled)

13. The image processing device according to claim 11,
wherein the denominator of the weight of the chroma component is calculated based on a denominator of the weight of the luma component, the bit depth difference, and a remainder difference, and
wherein the encoding section further encodes first weight denominator information indicating the denominator of the weight of the luma component and second weight denominator information indicating the remainder difference.

14. The image processing device according to claim 11,
wherein the image is an enhancement layer image that undergoes scalable video encoding, and
wherein the prediction section executes the weighted prediction for color gamut conversion or dynamic range conversion between layers.

15. The image processing device according to claim 11,
wherein the image is an enhancement layer image that undergoes scalable video encoding, and
wherein the first bit depth information indicates a difference between the first bit depth for a luma component of the enhancement layer image and a bit depth for a luma component of a base layer image.

16. An image processing device comprising:
an encoding section configured to encode a non-PCM sample of an image and a PCM sample of the image according to bit depths that are defined separately; and
a generation section configured to generate non-PCM bit depth information indicating a non-PCM bit depth and PCM bit depth information indicating a first bit depth difference between the non-PCM bit depth and a PCM bit depth,
wherein the encoding section further encodes the non-PCM bit depth information and the PCM bit depth information,
wherein the non-PCM bit depth information includes first bit depth information indicating a first bit depth for a luma component of the non-PCM sample and second bit depth information indicating a second bit depth difference between the first bit depth and a second bit depth for a chroma component of the non-PCM sample, and
wherein a fourth bit depth for a chroma component of the PCM sample is differentially encoded using a third bit depth for a luma component of the PCM sample and the second bit depth difference.

17. (canceled)

18. The image processing device according to claim 16,
wherein the fourth bit depth is calculated based on the third bit depth, the second bit depth difference, and a remainder difference, and
wherein the PCM bit depth information includes third bit depth information indicating the first bit depth difference and fourth bit depth information indicating the remainder difference.

19. The image processing device according to claim 16,
wherein the PCM bit depth information indicates a bit depth difference that differs according to a coding unit (CU) size.

20. The image processing device according to claim 19,
wherein the PCM bit depth information indicates a bit depth difference for a second CU size that is differentially encoded based on a bit depth difference for a first CU size.
